(19) United States
(12) Patent Application Publication
(10) Pub. No.: US 2009/0123086 A1
(43) Pub. Date: May 14, 2009

(54) VIEW ENVIRONMENT CONTROL SYSTEM

(75) Inventors: Takuya Iwanami, Chiba (JP); Takashi Yoshii, Chiba (JP); Yasuhiro Yoshida, Chiba (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka (JP)

(21) Appl. No.: 12/091,661

(22) PCT Filed: Jul. 31, 2006
(86) PCT No.: PCT/JP2006/315168

§ 371 Date: Apr. 25, 2008

(30) Foreign Application Priority Data
Oct. 31, 2005 (JP) 2005-316538
May 30, 2006 (JP) 2006-149491

(51) Int. Cl. G06K 9/40

(52) U.S. Cl. 382/274

(57) ABSTRACT

It is possible to control ambient illumination so as to be appropriate for an atmosphere of a scene to be imaged and shot setting intended by a video producer. A view environment control device includes a scene section detection processing unit (22) for a video to be displayed on a video display device (1) and a shot (atmosphere) estimation unit (23) of the video scene. The scene section detection processing unit (22) detects a video scene section and the shot (atmosphere) estimation unit (23) estimates the shot setting (atmosphere) by the illumination state of the shot where video is imaged and generates illumination control data appropriate for the scene, which is stored in (31). An illumination switching control unit (41) controls the illumination light of an illumination device (5) according to the illumination control data read from (31), thereby controlling the illumination appropriate for the video displayed on the video display device (1).

### TECHNICAL FIELD

The present invention relates to a view environment controlling apparatus, a system, a view environment controlling method, a data transmitting apparatus, and a data transmitting method capable of controlling illumination light around a video displaying apparatus adaptively to the atmosphere and the situation setting of a shot scene of video when displaying the video on the video displaying apparatus.

### BACKGROUND OF THE INVENTION

For example, when a video is displayed on a video displaying apparatus such as a television receiver or when a video is projected and displayed with the use of a projector apparatus, a technology is known that adjusts the surrounding illumination light in accordance with the displayed video to adds viewing enhancement effect such as enhancing the sense of reality, etc.

For example, patent document 1 discloses a light-color variable lighting apparatus that calculates a mixed light illuminance ratio of three primary colors in a light source for each frame from color signals (RGB) and a luminance signal (Y) of a color-television display video to perform light adjustment control in conjunction with the video. This light-color variable lighting apparatus picks up the color signals (RGB) and the luminance signal (Y) from the color-television display video, calculates an appropriate light adjustment illuminance ratio of three color lights (red light, green light, blue light) used for the light source from the color signals and the luminance signal, sets the illuminance of the three color lights in accordance with the illuminance, and mixes and outputs the three color lights as the illumination light.

For example, patent document 2 discloses an image staging lighting device that divides a television video into a plurality of parts and that detects an average hue of the corresponding divided parts to perform the lighting control around the divided parts. This image staging lighting device includes a lighting means that illuminates the periphery of the disposition location of the color television; the average hue is detected for the divided parts of the video corresponding to a part illuminated by the lighting means; and the lighting means is controlled based on the detected hue.

For example, in a method disclosed in patent document 3, instead of simply obtaining the average chromaticity and the average luminance of an entire screen of an image displaying apparatus, it is considered that a remaining part acquired by removing pixels of flesh-colored parts such as human faces is a background part in an image shown on the screen of the image displaying apparatus; only the RGB signals and luminance signal of the pixels of the background part are picked up to obtain the average chromaticity and the average luminance; and the lighting is controlled such that the chromaticity and the luminance of a wall behind the image displaying apparatus becomes identical to the average chromaticity and the average luminance of the entire screen or the background part other than the human flesh color.

Patent Document 1: Japanese Laid-Open Patent Publication No. 02-158094

Patent Document 2: Japanese Laid-Open Patent Publication No. 02-253503

Patent Document 3: Japanese Laid-Open Patent Publication No. 03-184203

### DISCLOSURE OF THE INVENTION

### Problems to be Solved by the Invention

Normally, a scene of video is created as a sequence of video based on a series of situation settings in accordance with the intention of video producers (such as a scenario writer and a director), for example. Therefore, to enhance the sense of reality and atmosphere at the time of viewing video, it is desirable to emit illumination light into a viewing space in accordance with a scene situation of the displayed video.

However, in the conventional technologies, the state of illumination light is varied depending on frame-by-frame changes in the luminance and the hue of video signals and, especially, in such a case that the degrees of changes in the luminance and the hue between frames are high, the illumination light is roughly varied and it is problematic that a viewer feels discomfort due to flickers. During display of one scene having no change in the situation setting, varying the illumination light depending on the frame-by-frame changes in the luminance and the hue spoils the atmosphere of the scene by contraries and is not desirable.

FIG. 25 is a view for explaining an example of the problem of the lighting control of the conventional technology. In the example shown in FIG. 25, a scene is created in a video shot with the situation setting that is an outdoor location at a moonlight night. This scene is made up of three shots (1, 2, 3) with different camera works. In the shot 1, a camera shoots a target that is a ghost in wide-angle shot. When switching to the shot 2, the ghost is shot in close-up. In the shot 3, the camera position is returned to that of the shot 1. These shots are intentionally configured as a sequence of scene having single continuous atmosphere although the camera works are different.

In this case, relatively dark images on the moonlight night are continued in the shot 1. If the illumination light is controlled in accordance with the luminance and chromaticity of the frames of these images, the illumination light becomes relatively dark. When the shot 1 is switched to the shot 2, the ghost shot in close-up forms relatively bright images. If the illumination light is controlled for each frame by the conventional technologies, when the shots are switched, the control of the illumination light is considerably changed and the bright illumination light is generated. When switching to the shot 3, the illumination light returns to the dark light as in the case of the shot 1.

That is, if the illumination light becomes dark and bright in a sequence of scene with single continuous situation (atmosphere), the atmosphere of the scene is spoiled by contraries and a viewer is made uncomfortable.

FIG. 26 is a view for explaining another example of the problem due to the variation of the lighting in a scene. In the example shown in FIG. 26, a scene is created in a video shot with the situation setting that is an outdoor location in the daytime under the clear sky. This scene consists of images acquired through continuous camera work without switching the camera. In this example, a video of a skier sliding down from above the camera to the vicinity of the camera is shot. The skier is dressed in red clothes and the sky is clear.

In the video of this scene, a blue sky area in the background is large in initial frames and the area of the skier in red clothing gradually increases as the skier slides down and approaches the camera. That is, as the scene of the video progresses, the rate of color making up the frames is changed.

In this case, if the illumination light is controlled using the chromaticity and luminance of each frame, the illumination light is changed from bluish light to reddish light. That is, the color of the illumination light is changed in a sequence of scene with single continuous situation (atmosphere), and the atmosphere of the scene is spoiled by contraries and a viewer is made uncomfortable.

The present invention was conceived in view of the above problems and it is therefore the object of the present invention to provide a view environment controlling apparatus, a view environment control system, a view environment controlling method, a data transmitting apparatus, and a data transmitting method capable of controlling the surrounding illumination light adaptively to the atmosphere and the situation setting of a shot scene intended by video producers to implement the optimum lighting control in the view environment.

### Means for Solving the Problems

In order to solve the above problems, a first technical means of the present invention is a view environment controlling apparatus controlling illumination light of a lighting device in accordance with a feature quantity of video data to be displayed, wherein the illumination light of the lighting device is retained substantially constant in the same scene of the video data.

A second technical means is the view environment controlling apparatus as defined in the first technical means, comprising: a scene section detecting means that detects a section of a scene making up the video data; a video feature quantity detecting means that detects a video feature quantity of each scene detected by the scene section detecting means; and a lighting switch controlling means that switches and controls the illumination light of the lighting device for each scene based on the detection result of the video feature quantity detecting means.

A third technical means is the view environment controlling apparatus as defined in the second technical means, comprising: a scene lighting data storage means that stores the detection result detected by the video feature quantity detecting means for each scene and time codes of scene start point and scene end point of each scene detected by the scene section detecting means as scene lighting data; and a video data storage means that stores the video data along with time code, wherein the lighting switch controlling means switches and controls the illumination light of the lighting device for each scene based on the scene lighting data read from the scene lighting data storage means and the time codes read from the video data storage means.

A fourth technical means is the view environment controlling apparatus as defined in the second technical means, comprising a video data accumulating means that accumulates video data of a predetermined number of frames after the scene start point of each scene detected by the scene section detecting means, wherein the video feature quantity detecting means uses the video data accumulated on the video data accumulating means to detect a video feature quantity of a scene started from the scene start point.

A fifth technical means is the view environment controlling apparatus as defined in the fourth technical means, comprising a video data delaying means that outputs the video data to be displayed with a delay of a predetermined time.

A sixth technical means is a view environment control system comprising the view environment controlling apparatus as defined in any one of the first to fifth technical means, and a lighting device having view environment illumination light controlled by the view environment controlling apparatus.

A seventh technical means is a view environment controlling method of controlling illumination light of a lighting device in accordance with a feature quantity of video data to be displayed, wherein the illumination light of the lighting device is retained substantially constant in the same scene of the video data.

An eighth technical means is the view environment controlling method as defined in the seventh technical means, comprising: a scene section detecting step of detecting a section of a scene making up the video data; a video feature quantity detecting step of detecting a video feature quantity of each scene detected at the scene section detecting step; and a lighting switch determining step of switching and controlling the illumination light of the lighting device for each scene based on the detection result of the video feature quantity detecting step.

A ninth technical means is the view environment controlling method as defined in the eighth technical means, wherein the scene section detecting step includes the steps of: detecting a scene start point for every frame of video data; recording the time code of the scene start point when the scene start point is detected; detecting a scene end point for every frame subsequent to the scene start point after the scene start point is detected; and recording the time code of the scene end point when the scene detection point is detected, and wherein the video feature quantity detecting step includes the steps of: reproducing video data of a scene section corresponding to the time codes of the recorded scene start point and scene end point; and detecting the video feature quantity of the scene with the use of the reproduced video data.

A tenth technical means is the view environment controlling method as defined in the eighth technical means, wherein the scene section detecting step includes the step of detecting a scene start point from video data, wherein the method further comprises the step of acquiring video data of a predetermined number of frames subsequent to the scene start point when the scene start point is detected, and wherein at the video feature quantity detecting step, the acquired video data of the predetermined number of frames are used to detect the video feature quantity of the scene started from the scene start point.

An eleventh technical means is the view environment controlling method as defined in the eighth technical means, wherein the scene section detecting step includes the step of detecting a scene start point from video data, and the step of detecting a scene end point from the video data, wherein the method further comprises the step of acquiring video data of a predetermined number of frames subsequent to the scene start point when the scene start point is detected, and the step of detecting a scene start point form the video data again if the scene end point is detected before acquiring the video data of a predetermined number of frames subsequent to the scene start point, and wherein at the video feature quantity detecting step, the video feature quantity of the scene started from the scene start point is detected using the acquired video data of the predetermined number of frames.

A twelfth technical means is the view environment controlling method as defined in the tenth or eleventh technical means, wherein the video data to be displayed are output with a delay of a predetermined time.

A thirteenth technical means is a data transmitting apparatus transmitting video data made up of one or more scenes, wherein scene delimitation position information indicating delimitation position of each scene of the video data is transmitted in addition to the video data.

A fourteenth technical means is the data transmitting apparatus as defined in the thirteenth technical means, wherein the scene delimitation position information is added per frame of the video data.

A fifteenth technical means is a data transmitting apparatus transmitting scene delimitation position information indicating delimitation position of each scene making up video data in response to a request from the outside, wherein the scene delimitation position information represents start frame of each scene making up the video data.

A sixteenth technical means is the data transmitting apparatus as defined in the fifteenth technical means, wherein the scene delimitation position information represents start frame of each scene making up the video data and end frames of the scenes.

A seventeenth technical means is a view environment controlling apparatus comprising: a receiving means that receives video data to be displayed on a displaying device and scene delimitation position information indicating delimitation position of each scene making up the video data, and a controlling means that uses a feature quantity of the video data and the scene delimitation position information to control illumination light of a lighting device disposed around the displaying device.

An eighteenth technical means is the view environment controlling apparatus as defined in the seventeenth technical means, wherein the controlling means retains the illumination light of the lighting device substantially constant in the same scene of the video data.

A nineteenth technical means is view environment control system comprising the view environment controlling apparatus as defined in the seventeenth or eighteenth technical means, and a lighting device having view environment illumination light controlled by the view environment controlling apparatus.

A twentieth technical means is a data transmitting method of transmitting video data made up of one or more scenes, wherein scene delimitation position information indicating delimitation position of each scene of the video data is transmitted in addition to the video data.

A twenty-first technical means is a data transmitting method of transmitting scene delimitation position information indicating delimitation position of each scene making up video data in response to a request from the outsider wherein the scene delimitation position information represents start frame of each scene making up the video data.

A twenty-second technical means is a view environment controlling method comprising the steps of: receiving video data to be displayed on a displaying device and scene delimitation position information indicating delimitation position of each scene making up the video data, and controlling illumination light of a lighting device disposed around the displaying device using a feature quantity of the video data and the scene delimitation position information.

A twenty-third technical means is the view environment controlling method as defined in the twenty-second technical means, wherein the illumination light of the lighting device is retained substantially constant in the same scene of the video data.

### EFFECT OF THE INVENTION

According to the present invention, illumination light of a view environment can appropriately be controlled adaptively to the atmosphere and the situation setting of a shot scene intended by video producers and the greater video effects can be acquired by giving a sense of reality to a viewer.

Especially, in the present invention, a video feature quantity is detected for each scene of video to be displayed to estimate the state of illumination light at the location where the scene was shot, and illumination light around a video displaying apparatus is controlled in accordance with the estimation result. Therefore, in a sequence of scene having single continuous atmosphere because of intention of video producers, etc., lighting can be made substantially constant in accordance with a video feature quantity detection result of the scene and a viewer can feel the sense of reality of the scene without uncomfortable feeling.

### BRIEF DESCRIPTION OF THE DRAWINGS

FIG. 1 is a view for explaining a main outline configuration of a view environment controlling apparatus according to the present invention.

FIG. 2 is a view for explaining components of video.

FIG. 3 is a block diagram for explaining one embodiment of the view environment controlling apparatus according to the present invention.

FIG. 4 is a block diagram for explaining another embodiment of the view environment controlling apparatus according to the present invention.

FIG. 5 is a block diagram for explaining yet another embodiment of the view environment controlling apparatus according to the present invention.

FIG. 6 is a flowchart for explaining an example of a flow of a scene delimitation detection processing and a situation (atmosphere) estimation processing in one embodiment of the view environment controlling apparatus according to the present invention.

FIG. 7 is a flowchart for explaining an example of a flow of the scene delimitation detection processing and the situation (atmosphere) estimation processing in another embodiment of the view environment controlling apparatus according to the present invention.

FIG. 8 is a flowchart for explaining an example of a flow of the scene delimitation detection processing and the situation (atmosphere) estimation processing in yet another embodiment of the view environment controlling apparatus according to the present invention.

FIG. 9 is a flowchart for explaining an example of the processing of a lighting switch controlling portion that performs switching control of a lighting apparatus based on the scene delimitation detection and situation (atmosphere) estimation results.

FIG. 10 is a view for explaining implementation of a color temperature estimation processing.

FIG. 11 is a flowchart for explaining an example of the scene delimitation detection processing.

FIG. 12 is a flowchart for explaining another example of the scene delimitation detection processing.

FIG. 13 is a block diagram of a main outline configuration of a video transmitting apparatus in a view environment control system of the present invention.

FIG. 14 is a view for explaining a layer configuration of encoded data of a moving image encoded in MPEG.

FIG. 15 is a view for explaining a scene change.

FIG. 16 is a block diagram of a main outline configuration of a video receiving apparatus in the embodiment corresponding to FIG. 13.

FIG. 17 is a block diagram of a lighting control data generating portion of FIG. 16.

FIG. 18 is a flowchart of the operation of the lighting control data generating portion of FIG. 16.

FIG. 19 is a block diagram of a main outline configuration of an external server apparatus in the view environment control system of the present invention.

FIG. 20 is an explanatory view of an example of a scene delimitation position information storage table in the view environment control system of FIG. 19.

FIG. 21 is a block diagram of a main outline configuration of a video receiving apparatus in the embodiment corresponding to FIG. 19.

FIG. 22 is a block diagram of a lighting control data generating portion of FIG. 21.

FIG. 23 is a flowchart of the operation of the lighting control data generating portion of FIG. 21.

FIG. 24 is a view of levels of color difference ΔE and general degrees of visual sense.

FIG. 25 is a view for explaining an example of the problem of the lighting variation of the conventional technology.

FIG. 26 is a view for explaining another example of the problem of the lighting variation of the conventional technology.

### EXPLANATION OF REFERENCE NUMERALS

1 . . . video displaying apparatus; 2 . . . situation (atmosphere) estimation processing; 3 . . . scene delimitation detection processing; 4 . . . view environment control; 5 . . . lighting apparatus; 10 . . . data transmitting portion; 20 . . . video recording apparatus; 21 . . . video data extracting portion; 22 . . . scene section detecting portion; 22a . . . start point detecting portion; 22b . . . end point detecting portion; 23 . . . situation (atmosphere) estimating portion; 24 . . . scene start point detecting portion; 25 . . . video data accumulating portion; 26 . . . lighting switch controlling portion; 27 . . . scene end point detecting portion; 31 . . . scene lighting data; 32 . . . video recording data; 40 . . . video reproducing apparatus; 41 . . . lighting switch controlling portion; 50 . . . video receiving apparatus; 60 . . . delay generating portion; 70 . . . video receiving apparatus; 101 . . . data multiplexing portion; 102 . . . transmitting portion; 131, 161 . . . receiving portion; 132, 162 . . . data demultiplexing portion; 133, 134 . . . delay generating portion; 135, 165 . . . lighting control data generating portion; 136 . . . video displaying apparatus; 137 . . . sound reproducing apparatus; 138 . . . lighting apparatus; 151 . . . receiving portion; 152 . . . data storage portion; 153 . . . transmitting portion; 166 . . . CPU; 167 . . . transmitting portion; and 168 . . . receiving portion.

### PREFERRED EMBODIMENTS OF THE INVENTION

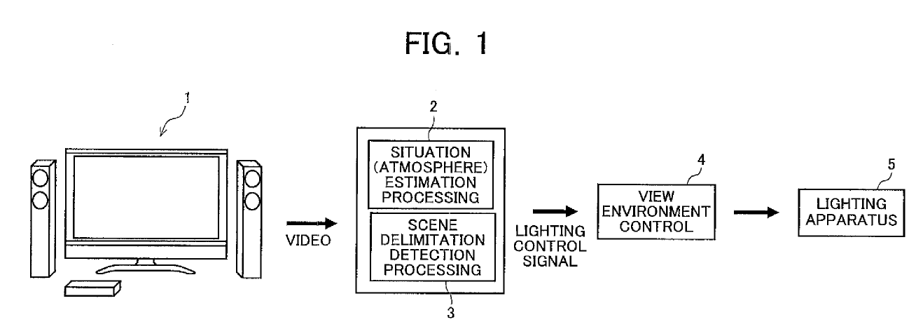

FIG. 1 is a view for explaining a main outline configuration of a view environment controlling apparatus according to the present invention. The view environment controlling apparatus includes a situation (atmosphere) estimation processing portion 2 that estimates the situation (atmosphere) of shot scenes of video for the video displayed on a video displaying apparatus 1 such as a television apparatus and a scene delimitation detection processing portion 3 that detects scene delimitations (start points, endpoints) of video. The view environment controlling apparatus also includes a view environment controlling portion 4 that outputs a lighting control signal for variably controlling the illumination light of the lighting apparatus 5 based on the estimation/detection results of the situation (atmosphere) estimation processing portion 2 and the scene delimitation detection processing portion 3 to control the view environment around the video displaying apparatus 1.

The lighting apparatus 5 for illuminating the surrounding environment is included around the video displaying apparatus 1. The lighting apparatus 5 can be made up of LEDs that emit lights of three primary colors, for example, RGB having predetermined hues. However, the lighting apparatus 5 may have any configuration which can control the lighting color and brightness of the surrounding environment of the video displaying apparatus 1, is not limited to the combination of LEDs emitting predetermined colors as described above, and may be made up of white LEDs and color filters, or a combination of white bulbs or fluorescent tubes and color filters, color lamps, etc., may also be applied. One or more of the lighting apparatuses 5 may be disposed.

The view environment controlling apparatus controls the lighting color and the lighting brightness of the lighting apparatus 5 by the view environment controlling portion 4 in accordance with the lighting control signal generated by the situation (atmosphere) estimation processing portion 2 and the scene delimitation detection processing portion 3. The lighting apparatus 5 is controlled by the lighting control signal such that the state of the illumination light becomes substantially constant while one scene of video is displayed. This enables the illumination light around the video displaying apparatus 1 to be controlled adaptively to the atmosphere and the situation setting of a shot scene intended by video producers and the advanced video effects can be acquired by giving a sense of reality to a viewer.

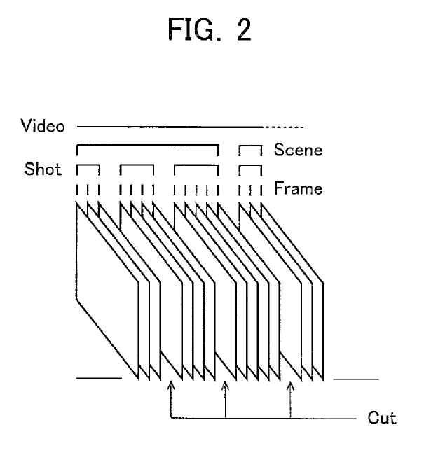

A configuration of video including scenes and shots related to the view environment control of the present invention will then be described with reference to FIG. 2. Video images may be considered to have three-layered configuration as shown in FIG. 2.

A first layer of video is a frame. The frame is a physical layer and indicates a single two-dimensional image. The frame is normally acquired at a rate of 30 frames per second.

A second layer is a shot. The shot is a frame sequence shot by a single camera. A third layer is a scene. The scene is a shot sequence having story continuity. In the present invention, the delimitations of scenes defined above are estimated for performing control such that the illumination light emitted from the lighting apparatus is retained substantially constant for each scene.

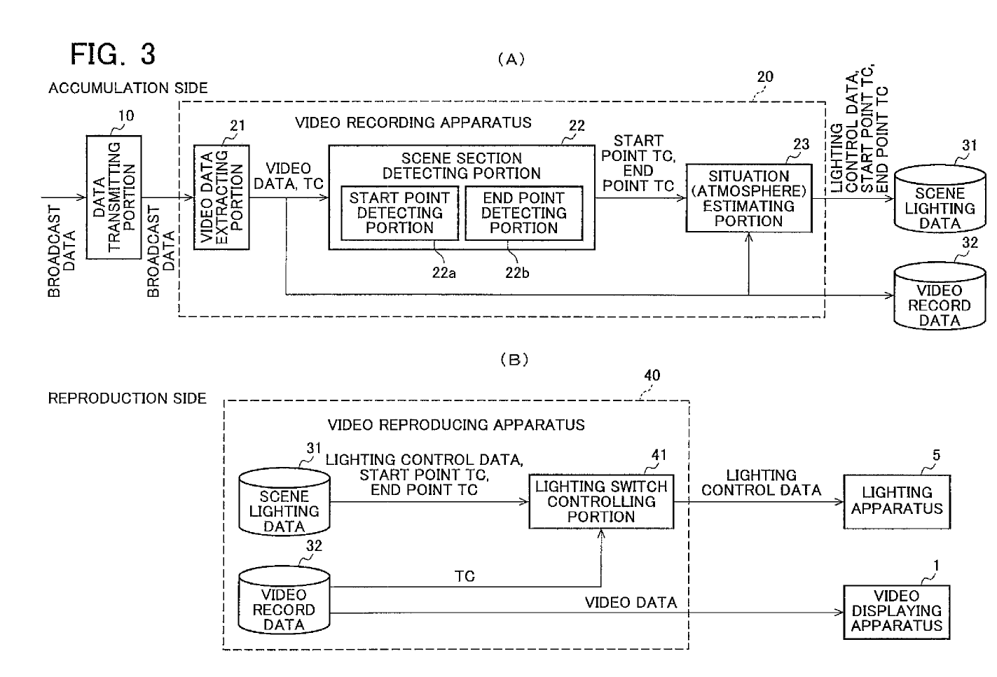

FIG. 3 is a block diagram for explaining one embodiment of the view environment controlling apparatus according to the present invention and shows a processing block on the data accumulation side in FIG. 3(A) and a processing block on the reproduction side in FIG. 3(B). The view environment controlling apparatus has a configuration that can once record video data into a video recording apparatus to control the illumination light of the lighting apparatus disposed around the video displaying apparatus when the video data are reproduced.

The configuration and processing on the data accumulation side of FIG. 3(A) will first be described. Broadcast data transferred through broadcast are taken as an example here. The broadcast data are input through a data transmitting portion 10 to a video recording apparatus 20. The data transmitting portion 10 includes a function of transferring broadcast data to the video recording apparatus and the specific configuration is not limited. For example, the portion may include a processing system that outputs broadcast signals received by a tuner in a form recordable into the video recording apparatus, may transfer broadcast data from another recording/reproducing apparatus or a recording medium to the video recording apparatus 20, or may transfer broadcast data through a network or other communication lines to the video recording apparatus 20.

The broadcast data transferred to the data transmitting portion 10 are input to a video data extracting portion 21 of the video recording apparatus 20. The video data extracting portion 21 extracts video data and TC (time code) included in the broadcast data. The video data are data of video to be displayed on the video displaying apparatus and the time code is information added to indicate reproduction time information of the video data. The time code is made up of information indicating hours (h):minutes (m):seconds (s): frames (f) of the video data, for example.

The video data and the TC (time code) extracted by the video data extracting portion 21 are input to a scene section detecting portion 22 and are recorded and retained in a recording means as video record data 32 reproduced by a video reproducing apparatus 40 described later.

The scene section detecting portion 22 of the video recording apparatus 20 detects a scene section of the video data extracted by the video data extracting portion 21. The scene section detecting portion 22 includes a start point detecting portion 22a that detects a start point of the scene and an end point detecting portion 22b that detects an end point of the scene. The start point detecting portion 22a and the end point detecting portion 22b detect the start point and the end point of the scene and the scene section detecting portion 22 outputs a start point TC (time code) and an end point TC (time code). The start point TC and the end point TC are generated from the TC extracted by the video data extracting portion 21.

An situation (atmosphere) estimating portion (corresponding to a video feature quantity detecting means of the present invention) 23 uses the start point TC and the end point TC detected by the scene section detecting portion 22 to estimate the situation (atmosphere) where the scene is shot from the video feature quantity of the scene from the start point to the end point. The situation (atmosphere) is used to estimate the state of the surrounding light when scenes are shot and the situation (atmosphere) estimating portion 23 generates lighting control data for controlling the lighting apparatus in accordance with the estimation result and outputs the lighting control data along with the start point TC and the end point TC of the scene. The lighting control data, the start point TC, and the end point TC are recorded and retained as scene lighting data 31.

The detection of the scene sections in the scene section detecting portion 22 is executed and processed for the entire length (or a portion based on user's setting) of the input video data and all the scene sections included in the target video data are detected. The situation (atmosphere) estimating portion 23 estimates the situation (atmosphere) for all the scenes detected by the scene section detecting portion 22 and generates the lighting control data for each scene.

The lighting control data, the start point TC, and the end point TC are generated for each of all the target scenes and are recorded and retained as the scene lighting data 31 in a storage means.

The storage means (such as HDD, memory, and other recording media) having the scene lighting data 31 and the video record data 32 stored thereon may be included in the video recording apparatus 20 or may be included in the video reproducing apparatus 40. The storage means of a video recording/reproducing apparatus integrating the video recording apparatus 20 and the video reproducing apparatus 40 may also be used.

Although specific examples of the scene section detection processing and the situation (atmosphere) estimation processing will be described later, the processing techniques are not particularly limited in the present invention and techniques are appropriately applied to detect the scene sections making up the video data and to estimate the state of the surrounding light at the time of shooting of the scenes. This applies to the scene start-point/end-point detection processing and the situation (atmosphere) estimation processing in the following embodiments.

The configuration and processing on the data reproduction side of FIG. 3(B) will then be described. The video reproducing apparatus 40 uses the scene lighting data 31 and the video record data 32 stored in the predetermined storage means to perform the display control of the video data for the video displaying apparatus 1 and the control of the illumination light of the lighting apparatus 5.

The video reproducing apparatus 40 outputs the video data included in the video record data 32 to the video displaying apparatus 1 to display the video data on the display screen.

A lighting switch controlling portion 41 acquires the scene lighting data 31 (the lighting control data, the start point TC, and the end point TC) associated with the video data displayed as video. A reproduced scene is determined in accordance with the TC of the reproduced and displayed video record data and the start point TC and the end point TC of the acquired scene lighting data 31 and the lighting apparatus 5 is controlled with the use of the lighting control data corresponding to the reproduced scene. Since the lighting control data output to the lighting apparatus 5 are synchronized with the video data output to the video displaying apparatus 1, the lighting control data are switched in accordance with switching of the scenes of the reproduced video in the video displaying apparatus 1.

The lighting apparatus 5 is made up of a light source such as LED capable of controlling the lighting color and brightness as above and can switch the lighting color and brightness in accordance with the lighting control data output from the lighting switch controlling portion 41.

The accumulation-type view environment controlling apparatus can switch and control the surrounding lighting for each scene when the video data are reproduced as described above.

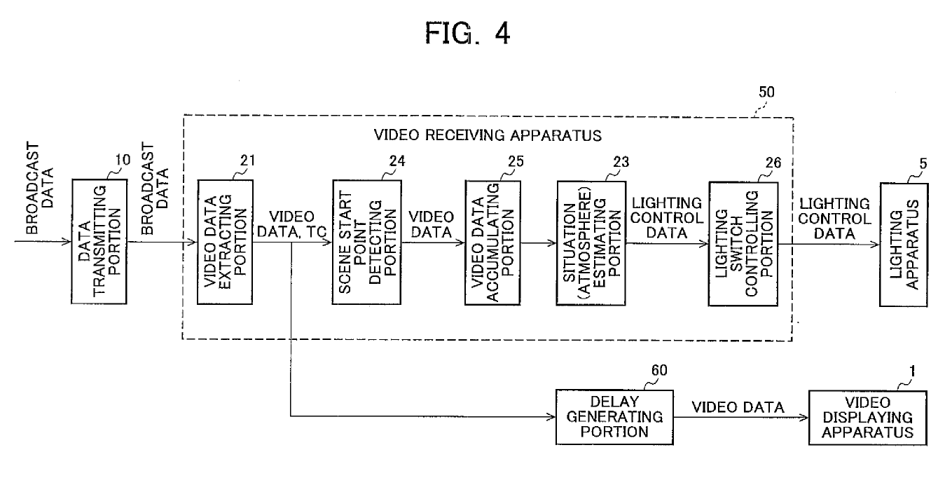

FIG. 4 is a block diagram for explaining another embodiment of the view environment controlling apparatus according to the present invention. The view environment controlling apparatus of this embodiment has a configuration of displaying the input video data on the video displaying apparatus in real time while controlling the illumination light of the lighting apparatus disposed around the video displaying apparatus.

The case of inputting and reproducing the broadcast data transferred through broadcast will be described in this embodiment. The broadcast data are input through the data transmitting portion 10 to a video receiving apparatus 50. The data transmitting portion 10 has the same function as FIG. 3.

The broadcast data transferred to the data transmitting portion 10 are input to the video data extracting portion 21 of the video receiving apparatus 50. The video data extracting portion 21 extracts video data and TC (time code) included in the broadcast data.

The video data and the TC extracted by the video data extracting portion 21 are input to a scene start point detecting portion 24. The scene start point detecting portion 24 detects the start points of scenes of the video data extracted by the video data extracting portion 21 and outputs the video data and the start point TC (time code). The start point TC is generated from the TC extracted by the video data extracting portion 21. In this embodiment, the scene start point detecting portion 24 corresponds to the scene section detecting portion of the present invention.

A video data accumulating portion 25 temporarily accumulates a predetermined number of frames at the beginning part of video data for each of scenes to determine the situation (atmosphere) of the scenes based on the start point TC (time code) extracted by the scene start point detecting portion 24. The predetermined number may preliminarily be defined by default or may arbitrarily and variably be set in accordance with user's operations. For example, the predetermined number is set to 100 frames.

The situation (atmosphere) estimating portion (corresponding to the video feature quantity detecting means of the present invention) 23 uses a feature quantity of each scene detected from the video data of the predetermined number of frames accumulated in the video data accumulating portion 25 and the start point TC (time code) of the scene to estimate the situation (atmosphere) of the video scene. The situation (atmosphere) of the scene corresponds to the state of the illumination light when the video is shot, as described above.

The situation (atmosphere) estimating portion 23 generates the lighting control data for controlling the lighting apparatus 5 in accordance with the estimation result and outputs the lighting control data to a lighting switch controlling portion 26.

The detection of the scene start points in the scene start point detecting portion 24 is executed and processed for the entire length (or a portion based on user's setting) of the input video data and the start points of all the scenes included in the target video data are detected. The video data accumulating portion 25 accumulates a predetermined number of frames at the beginning part for each scene. The situation (atmosphere) estimating portion 23 detects the video feature quantities of the accumulated scenes to estimate the situations (atmospheres) of the scenes and generates the lighting control data for each scene.

On the other hand, the video data to be displayed on the video displaying apparatus 1 are input from the video data extracting portion 21 to a delay generating portion (corresponding to a vide data delaying means of the present invention) 60, subjected to a delay processing to be synchronized with the lighting control data output from the lighting switch controlling portion 26, and output to the video displaying apparatus 1.

That is, when the input video data are displayed on the video displaying apparatus 1, a processing time is required for the video data accumulation processing and the situations (atmospheres) estimation processing and a time difference is generated between the input of the broadcast data and the output of the lighting control data. The delay generating portion 60 delays the output of the video data to the video displaying apparatus 1 by the time difference. This synchronizes the lighting control data output from the video receiving apparatus 50 to the lighting apparatus 5 with the video data output to the video displaying apparatus 1 and the illumination light of the lighting apparatus 5 can be switched at the timing corresponding to the switching of the displayed video scenes.

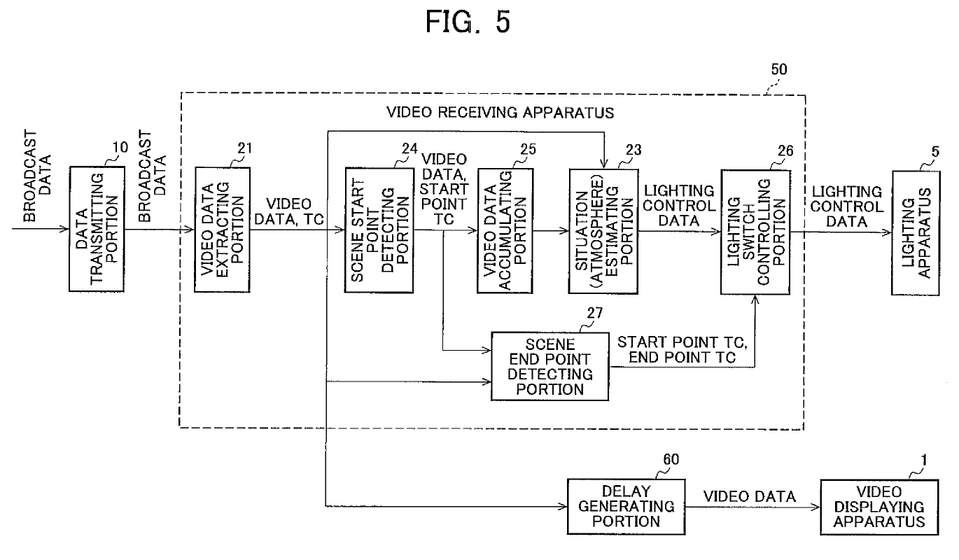

FIG. 5 is a block diagram for explaining yet another embodiment of the view environment controlling apparatus according to the present invention. The view environment controlling apparatus of this embodiment displays the input video data on the video displaying apparatus in real time while controlling the illumination light of the lighting apparatus disposed around the video displaying apparatus and has a configuration of FIG. 4 with a scene endpoint detecting portion 27 added. In this embodiment, the scene start point detecting portion 24 and the scene end point detecting portion 27 correspond to a scene section detecting means of the present invention.

The scene start point detecting portion 24 of the video receiving apparatus 70 detects the start points of scene of the video data extracted by the video data extracting portion 21 and outputs the video data and the start point TC (time code) as is the case with FIG. 4. The video data accumulating portion 25 and the situation (atmosphere) estimating portion 23 execute similar processing as shown in FIG. 4 and the situation (atmosphere) estimating portion 23 outputs the lighting control data for controlling the lighting apparatus 5.

Although only the start points of scenes are detected to generate the lighting control data in the embodiment of FIG. 4, the scene end point detecting portion 27 detects the end points of scenes to control the switching of the illumination light based on the detection result.

The video data and the TC (time code) extracted by the video data extracting portion 21 are input to the scene end point detecting portion 27 and the start point TC detected by the scene start point detecting portion 24 is also input. The video data may be input from the scene start point detecting portion 24.

The scene end point detecting portion 27 detects the end points of scenes of the input video data and outputs the start point TC and the end point TC of the scenes to the lighting switch controlling portion 26.

The lighting switch controlling portion 26 outputs the lighting control data of the scene to the lighting apparatus 5 in accordance with the lighting control data output from the situation (atmosphere) estimating portion (corresponding to the video feature quantity detecting means of the present invention) 23. The control of the lighting apparatus 5 with the same lighting control data is retained until the scene end point is detected by the scene end point detecting portion 27.

The detection of the scene start points and end points in the scene start point detecting portion 24 and the scene end point detecting portion 27 is executed and processed for the entire length (or a portion based on user's setting) of the input video data and the start points and the end points of all the scenes included in the target video data are detected. The video data accumulating portion 25 accumulates a predetermined number of frames at the beginning part for each scene. The situation (atmosphere) estimating portion 23 detects the video feature quantities of the accumulated scenes to estimate the situations (atmospheres) of the scenes and generates the lighting control data for each scene.

The delay generating portion (corresponding to the vide data delaying means of the present invention) 60 inputs the video data from the video data extracting portion 21 as in the case of the configuration of FIG. 4r executes the delay processing such that the video data are synchronized with the lighting control data output from the lighting switch controlling portion 26, and outputs the video data to the video displaying apparatus 1. This synchronizes the lighting control data output from the video receiving apparatus 70 to the lighting apparatus 5 with the video data output to the video displaying apparatus 1 and the illumination light of the lighting apparatus 5 can be switched at the timing corresponding to the switching of the displayed video scenes.

In this embodiment, the scene start point and end point are detected to execute the situation (atmosphere) estimation processing and the lighting switching processing. That is, if a scene is terminated before accumulating the predetermined number of frames from the start of the scene, the situation (atmosphere) estimation processing and the lighting switching processing are not executed based on the video data of the scene. For example, if an unnecessary short scene (or frame, shot) exists between scenes, these scenes can be removed to execute the situation (atmosphere) estimation processing and to execute the switching control of the surrounding illumination light.

In some cases, for example, a very short explanatory video (shot) consisting of a character screen may be inserted between scenes as an unnecessary scene. Since these shots are displayed for a very short time, the control of the illumination light is not necessary, and if the illumination light is controlled, a sense of discomfort may be generated on the contrary. In this embodiment, the situation (atmosphere) of a desired scene section can appropriately be estimated to perform more effective illumination light control.

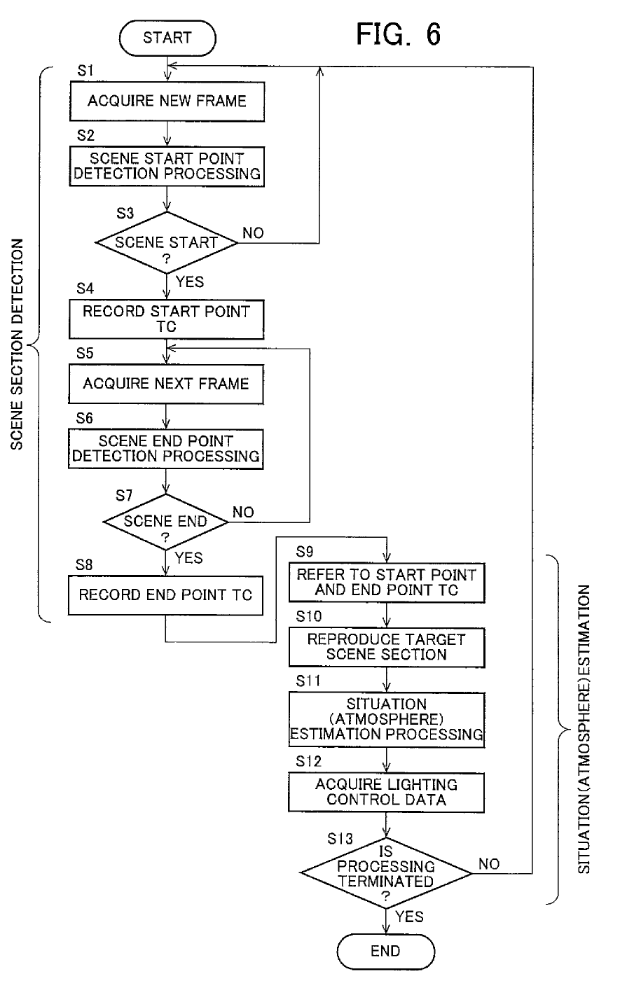

FIG. 6 is a flowchart for explaining an example of a flow of the scene delimitation detection processing and the situation (atmosphere) estimation processing and depicts an example of the processing in the accumulation-type view environment controlling apparatus according to one embodiment shown in FIG. 3(A).

In the scene section detection processing of the scene section detecting portion 22, first, a new frame is acquired from video data (step S1). The scene start point detection processing is then executed for the acquired frame and it is determined whether the frame is the scene start point (frame) (steps S2, S3).

If the acquired frame is not the scene start point, the flow goes back to step S1 to further acquire a new frame and the scene start point detection processing is executed. If the acquired frame is the scene start point, the TC at this point is recorded as the start point TC (step S4).

The next frame is then acquired from the video data (step S5) and the scene end point detection processing is executed to determine whether the frame is the scene end point (steps S6, S7). If the acquired frame is not the scene end point, the flow goes back to step S5 to further acquire the next frame and the scene end point detection processing is executed. If the acquired frame is the scene end point, the TC at this point is recorded as the end point TC (step S8). The scene section detection processing is terminated by executing the above processing.

The situation (atmosphere) estimating portion 23 then executes the situation (atmosphere) estimation processing. The start point TC and the end point TC recorded in the above scene section detection processing are sent to the situation (atmosphere) estimating portion 23. The situation (atmosphere) estimating portion 23 refers to the start point TC and the end point TC (step S9) and reproduces the target scene section (step S10). The feature quantity of the video data of the target scene section is detected to execute the situation (atmosphere) estimation processing for the target scene section (step S11) and the lighting control data for controlling the lighting apparatus are acquired based on the estimation processing result (step S12).

It is determined whether the processing is terminated (step S13). For example, if the video data are terminated, the scene section detection processing and the situation (atmosphere) estimation processing are also terminated, and if the video data further continue, the flow goes back to step S1 to continue the scene section detection processing.

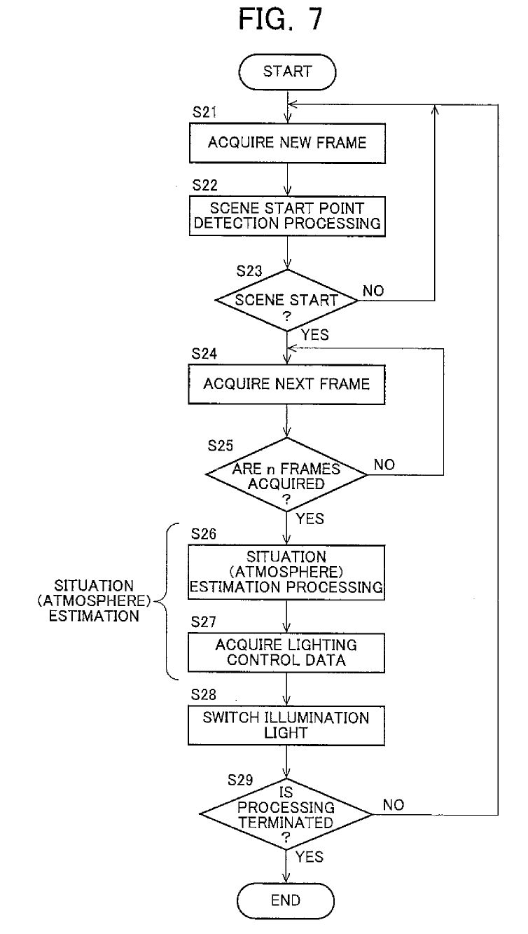

FIG. 7 is a flowchart for explaining another example of a flow of the scene delimitation detection processing and the situation (atmosphere) estimation processing and depicts an example of the processing in the real-time view environment controlling apparatus according to another embodiment shown in FIG. 4.

In the scene start point detection processing of the scene start point detecting portion 24, first, a new frame is acquired from video data (step S21). The scene start point detection processing is then executed for the acquired frame and it is determined whether the frame is the scene start point (frame) (steps S22, S23).

If the acquired frame is not the scene start point, the flow goes back to step S21 to further acquire a new frame and the scene start point detection processing is executed. If the acquired frame is the scene start point, the next frame is further acquired (step S24).

It is then determined whether the number of acquired frames from the scene start point reaches the predetermined number n of the frames by acquiring the next frame at step S24 (step S25). If the number of accumulated frames from the scene start point does not reach n frames, the flow goes back to step S24 to acquire the next frame. If the number of accumulated frames from the scene start point reaches n frames, the flow goes to the situation (atmosphere) estimation processing. The video data of the acquired n frames are accumulated in the video data accumulating portion 25.

The situation (atmosphere) estimating portion 23 uses the video data of the n frames accumulated in the video data accumulating portion 25 and detects the video feature quantity to execute the estimation processing of the situation (atmosphere) of the scene (step S26) and acquires the lighting control data for controlling the lighting apparatus 5 based on the estimation processing result (step S27). The switching control of the illumination light is performed by the lighting apparatus 5 based on the lighting control data (step S28), and it is then determined whether the processing is terminated (step S29). For example, if the video data are terminated, the scene section detection processing and the situation (atmosphere) estimation processing are also terminated, and if the video data further continue, the flow goes back to step S21 to acquired a new frame.

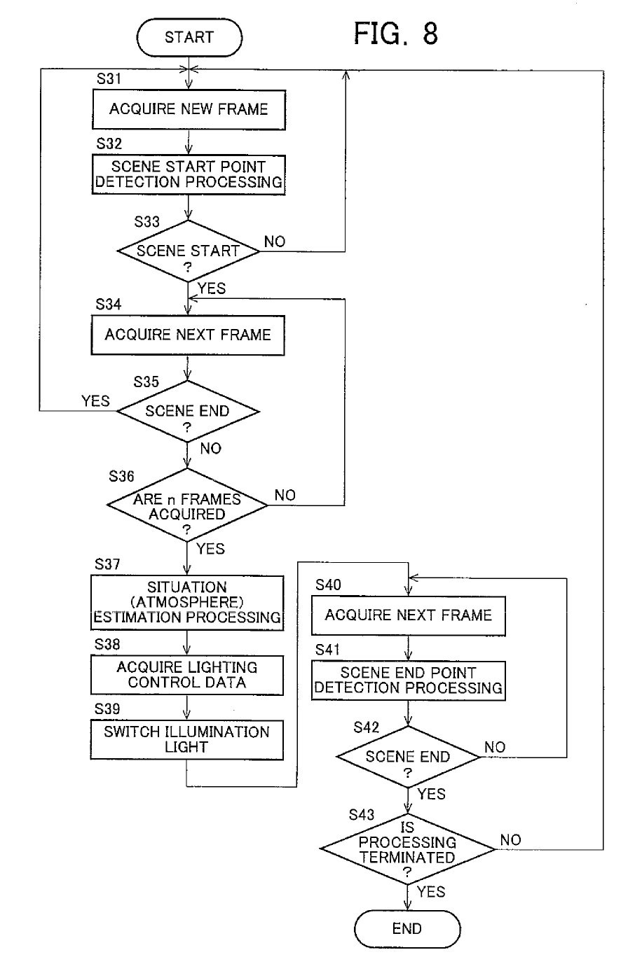

FIG. 8 is a flowchart for explaining another example of the flow of the scene delimitation detection processing and the situation (atmosphere) estimation processing and depicts an example of the processing in the real-time view environment controlling apparatus according to another embodiment shown in FIG. 5.

In the scene start point detection processing of the scene start point detecting portion 24, first, a new frame is acquired from video data (step S31). The scene start point detection processing is then executed for the acquired frame and it is determined whether the frame is the scene start point (frame) (steps S32, S33).

If the acquired frame is not the scene start point, the flow goes back to step S31 to further acquire a new frame and the scene start point detection processing is executed. If the acquired frame is the scene start point, the next frame is acquired (step S34). It is then determined whether the frame is the scene end point (frame), and if the frame is the scene endpoint, the flow goes back to step S31 to acquire a new frame. If the frame acquired at step S34 is not the scene end point, it is determined whether the number of acquired frames from the scene start point reaches the predetermined number n of the frames (step S36). If the number of accumulated frames from the scene start point does not reach n frames, the flow goes back to step S34 to acquire the next frame. If the number of accumulated frames from the scene start point reaches n frames, the flow goes to the situation (atmosphere) estimation processing. The video data of the acquired n frames are accumulated in the video data accumulating portion 25.

The situation (atmosphere) estimating portion 23 uses the video data of the n frames acquired in the video data accumulating portion 25 and detects the video feature quantity to execute the estimation processing of the situation (atmosphere) of the scene (step S37) and acquires the lighting control data for controlling the lighting apparatus 5 based on the estimation processing result (step S38). The switching control of the illumination light is performed by the lighting apparatus 5 based on the lighting control data (step S39).

The next frame is subsequently acquired (step S40) and the scene end point detection processing is executed for the acquired frame to determine whether the acquired frame is the scene end point (frame) (steps S41, S42).

If the scene is not ended in the scene end point detection processing, the flow goes back to step S40 to acquire the next frame. If the scene is ended, it is further determined whether the processing is terminated (step S43). For example, if the video data are terminated, the scene section detection processing and the situation (atmosphere) estimation processing are also terminated, and if the video data further continue, the flow goes back to step S31 to acquired a new frame.

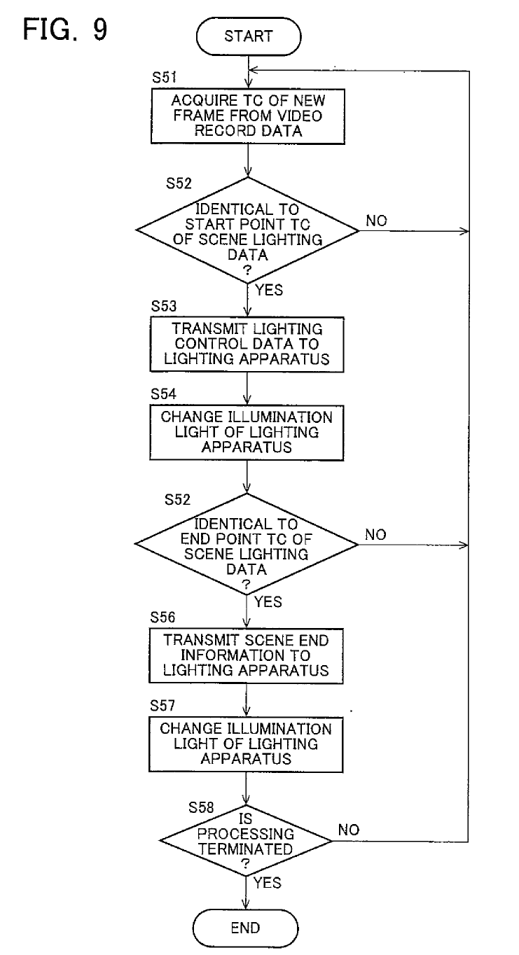

FIG. 9 is a flowchart for explaining an example of the processing of the lighting switch controlling portion that performs switching determination for the lighting apparatus based on the scene delimitation detection and situation (atmosphere) estimation results and corresponds to an example of the processing of the lighting switch controlling portion 41 of the accumulation-type view environment controlling apparatus according to one embodiment shown in FIG. 3(B).

The lighting switch controlling portion 41 first acquires TC (time code) of a new frame from the video record data 32 recorded by the video recording apparatus on the video data accumulation side (step S51). The start point TC of the scene lighting data 31 stored by the video recording apparatus is compared with the TC of the new frame acquired at step S51 to determined whether these TCs are identical (step S52). If the start point TC and the TC of the acquired frame are not identical, the flow goes back to step S51 to acquire TC of a new frame.

If the start point TC and the TC of the new frame are identical at step S52, the lighting switch controlling portion 41 transmits to the lighting apparatus 5 the lighting control data of the scene started from that frame (step S53). The lighting apparatus 5 changes the illumination light in accordance with the transmitted lighting control data (step S54).

The lighting switch controlling portion 41 compares the end point TC of the scene lighting data 31 stored by the video recording apparatus with the TC of the new frame acquired at step S51 to determined whether these TCs are identical (step S55). If the end point TC and the TC of the acquired frame are not identical, the flow goes back to step S51 to acquire TC of a new frame. If the end point TC and the TC of the new frame are identical, the scene end information indicating the end of the scene is transmitted to the lighting apparatus 5 (step S56). The scene end information is included in the lighting control data and, for example, the lighting control data (R,G,B)=(0,0,0) can be used.

The lighting apparatus 5 changes the illumination light of the lighting apparatus in accordance with the transmitted scene end information (step S57). It is then determined whether the processing is terminated (step S58), and if the processing is not terminated, the flow goes back to step S51 to acquire TC of a new frame.

A specific example of the situation (atmosphere) estimation technique implemented in the embodiments will then be described. In the situation (atmosphere) estimation processing, the lighting condition and the situation setting (atmosphere) are estimated for the location where the video was shot based on the feature quantity of the video data to be displayed as above and, for example, the sensor correlation method can be applied that is described in Tominaga Shoji, Ebisui Satoru, and B. A. WANDELL “Color Temperature Estimation of Scene Illumination”, IEICE Technical Report, PRMU99-184, 1999, although the processing technique is not limited in the present invention.

In the sensor correlation method, a color range occupied by sensor output are preliminarily obtained in the sensor space for each color temperature and a color temperature is estimated by checking correlation between the color range and the acquired image pixel distribution.

For example, in the present invention, the above sensor correlation method can be applied to estimate the color temperature of the lighting at the time of shooting of the video from the video data of scenes.

In the procedure of the processing method, the color ranges occupied by sensor output are preliminarily obtained; all the pixels of target pixels are normalized; the normalized (R,B) coordinate values are plotted on the RB plane; and the color range having the highest correlation with the (R,B) coordinate value of the target image is estimated as the color temperature of the target image. The color ranges are obtained every 500 K, for example.

In the estimation of color temperature, a color range is defined that may be occupied by the sensor output for each color temperature for classification of the scene lighting. In this case, the RGB values of the sensor output are obtained for various object surfaces under the spectral distribution of color temperatures. A two-dimensional illumination light range is used that is the convex hull of the RGB projected on the RB plane. The illumination light ranges can be formed with the 500-K color ranges occupied by the sensor output as above.

In the sensor correlation method, the scaling operation processing of image data is necessary for adjusting the overall luminance difference between images. It is assumed that an ith pixel of the target pixels is Ii and that the maximum value is Imax. For the luminance adjustment between different images, the sensor output is normalized with the RGB and the maximum value as follows.

(RGB)=(R/Imax,G/Imax,B/Imax)

Imax=max(Ri²+Gi²+Bi²)^{1/2}

The normalized (R,B) coordinate values are plotted on the RB plane with the lighting color ranges projected. The lighting color ranges are used as reference color ranges and are compared with the coordinate value of the plotted target image. The reference color range having the highest correlation with the coordinate value of the target image is selected and the color temperature is determined by the selected reference color range.

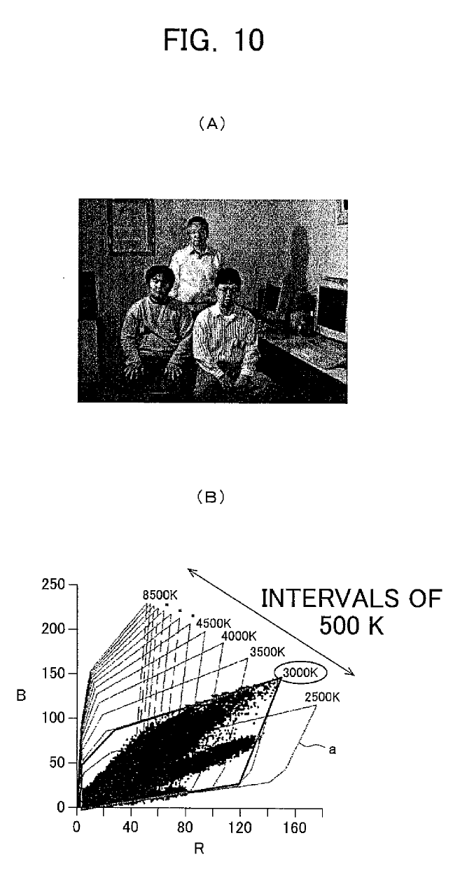

FIG. 10 is a view for explaining implementation of a color temperature estimation processing; FIG. 10(A) is a view of a shot image example in a room under an incandescent bulb; and FIG. 10(B) is a view of an example of the color ranges on the RB plane (RB sensor plane) and the RB coordinate values of the target image. The color temperature of the incandescent bulb is 2876 K.

As shown in FIG. 10(B), color ranges occupied by the sensor output are preliminarily obtained on the RB plane at the intervals of 500 K. The (R,B) coordinate values obtained by normalizing the target image shown in FIG. 10(A) are plotted on the RB plane.

As shown in FIG. 10(B), the plotted (R,B) coordinate values of the target image have the highest correlation with the color range of 3000K and, in this example, it is estimated that the target image is 3000 K.

The situation (atmosphere) estimating portion 23 can estimate the color temperature at the time of the shooting of the video data with the use of the above processing example and can generate the lighting control data in accordance with this estimation value. The lighting apparatus 5 can control the illumination light in accordance with the lighting control data as above to illuminate the periphery of the video displaying apparatus such that the color temperature at the time of the shooting of the video data is reproduced.

It is needless to say that the color signals and the luminance signals of a predetermined screen area included in the video data to be displayed may directly be used for the video feature quantities of the scenes used in the situation (atmosphere) estimation processing as in the case of the above conventional examples, for example.

Various additional data such as audio data and caption data may also be used along with the video data to execute the situation (atmosphere) estimation processing.

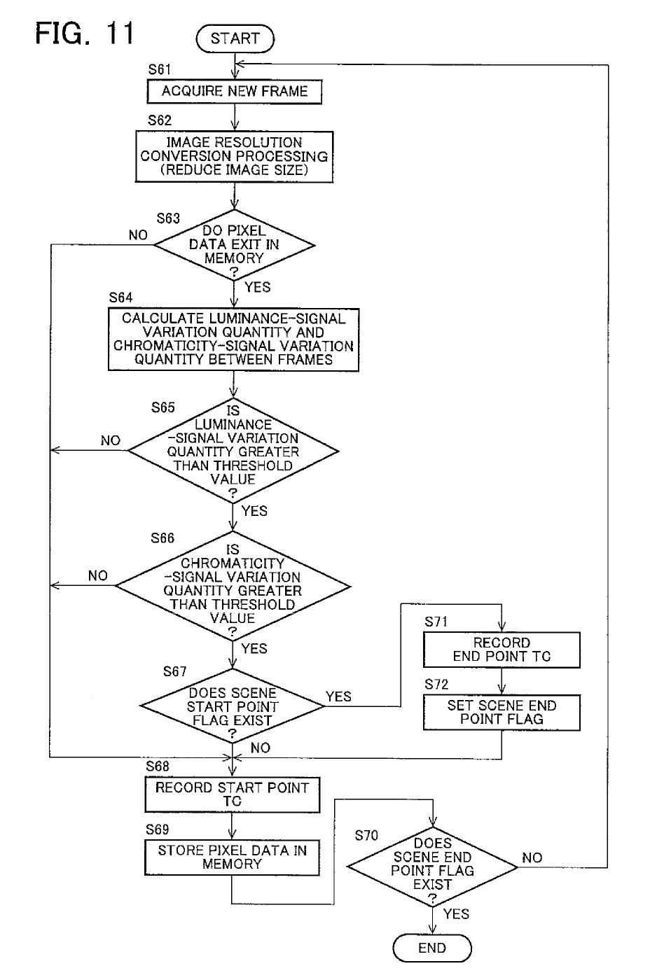

A specific processing example of the video scene delimitation detection processing portion 3 will then be described. FIG. 11 is a flowchart for explaining an example of the scene delimitation detection processing and depicts a processing example of the scene section detecting portion 22 in the accumulation-type view environment controlling apparatus according to one embodiment shown in FIG. 3.

The scene section detecting portion 22 first acquires a new frame from the video data extracted by the video data extracting portion 21 (step S61). An image resolution converting processing is then executed to reduce the image size (step S62).

The scene section detecting portion 22 then determines whether pixel data exist in a memory (not shown) (step S63), and if the pixel data exist in the memory, the inter-frame luminance-signal variation quantity and chromaticity-signal variation quantity are calculated between the frame consisting of the pixel data and the frame acquired at step S61 (step S64).

The scene section detecting portion 22 determines whether the luminance-signal variation quantity is greater than a predetermined threshold value (step S65) and also determines whether the chromaticity-signal variation quantity is greater than a predetermined threshold value (step S66). If the luminance-signal variation quantity is greater than the predetermined threshold value and the chromaticity-signal variation quantity is greater than the predetermined threshold value, it is determined whether a scene start point flag exists in the frame acquired at step S61 (step S67). If no pixel data exist in the memory at step S63, if the luminance-signal variation quantity is not greater than the threshold value at step S65, or if the chromaticity-signal variation quantity is not greater than the threshold value at step S66, the pixel data of the frame acquired at step S61 are stored in the memory (step S69).

If no scene start point flag exists at step S67, the TC of the frame acquired at step S61 is recorded as the start point TC (step S68), and the pixel data of the frame are stored in the memory (step S69).

If the scene start point flag exists at step S67, the TC of the frame acquired at step S61 is recorded as the end point TC (step S71); a scene end point flag is set (step S72); and the pixel data are stored in the memory (step S69).

After the pixel data are stored in the memory at step S69, the scene section detecting portion 22 determines whether the scene end point flag exists (step S70) and terminates the processing related to the scene section detection if the scene end point flag exists or goes back to step S61 to acquire a new frame if no scene end point flag exists.

In this example, the luminance-signal variation quantity and the chromaticity-signal variation quantity between frames are monitored to detect a scene section, and when these values are greater than the respective predetermined threshold values, the start point or the end point of the scene is determined. That is, in this example, if variation of luminance or variation of chromaticity is equal to or greater than a certain level when the frame is switched, it is determined that the scene is switched. Utilizing the chromaticity-signal in addition to the luminance signal has the advantages that the chromaticity signal can express actually existing colors and the scene section detection can accurately be performed.

In the real-time view environment controlling apparatus according to another embodiment shown in FIGS. 4 and 5, the processing after step S67 of FIG. 11 is not necessary.

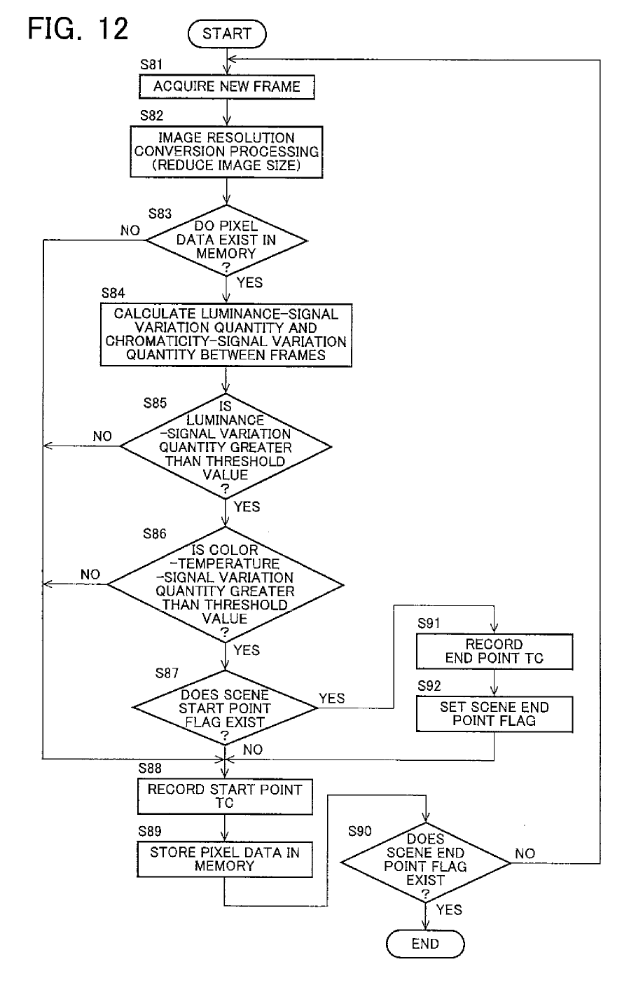

FIG. 12 is a flowchart for explaining another example of the scene delimitation detection processing and depicts another processing example of the scene section detecting portion 22 in the accumulation-type view environment controlling apparatus according to one embodiment shown in FIG. 3. In this embodiment, as compared to the processing example of FIG. 11, the color temperature signal is used instead of the chromaticity signal.

The scene section detecting portion 22 first acquires a new frame from the video data extracted by the video data extracting portion 21 (step S81). An image resolution converting processing is then executed to reduce the image size (step S82).

The scene section detecting portion 22 then determines whether pixel data exist in a memory (not shown) (step S83), and if the pixel data exist in the memory, the inter-frame luminance-signal variation quantity and color-temperature-signal variation quantity are calculated between the frame consisting of the pixel data and the frame acquired at step S81 (step S84).

The scene section detecting portion 22 determines whether the luminance-signal variation quantity is greater than a predetermined threshold value (step S85) and also determines whether the color-temperature-signal variation quantity is greater than a predetermined threshold value (step S86). If the luminance-signal variation quantity is greater than the predetermined threshold value and the color-temperature-signal variation quantity is greater than the predetermined threshold value, it is determined whether a scene start point flag exists in the frame acquired at step S81 (step S87). If no pixel data exist in the memory at step S83, if the luminance-signal variation quantity is not greater than the threshold value at step S85, or if the color-temperature-signal variation quantity is not greater than the threshold value at step S86, the pixel data of the frame acquired at step S81 are stored in the memory (step S89).

If no scene start point flag exists at step S87, the TC of the frame acquired at step S81 is recorded as the start point TC (step S88), and the pixel data of the frame are stored in the memory (step S89).

It the scene start point flag exists at step S87, the TC of the frame acquired at step S81 is recorded as the end point TC (step S91); a scene end point flag is set (step S92); and the pixel data are stored in the memory (step S89).

After the pixel data are stored in the memory at step S89, the scene section detecting portion 22 determines whether the scene end point flag exists (step S90) and terminates the processing related to the scene section detection if the scene end point flag exists or goes back to step S81 to acquire a new frame if no scene end point flag exists.

In this example, the luminance-signal variation quantity and the color-temperature-signal variation quantity between frames are monitored to detect a scene section, and when these values are greater than the respective predetermined threshold values, the start point or the end point of the scene is determined. That is, in this example, if variation of luminance or variation of chromaticity is equal to or greater than a certain level when the frame is switched, it is determined that the scene is switched. Utilizing the color temperature signal in stead of the luminance signal has the advantage that incorrect estimation of color other than the lighting color is prevented since the color temperature signal can express actually existing colors.

In the real-time view environment controlling apparatus according to another embodiment shown in FIGS. 4 and 5, the process after step S87 of FIG. 12 is not necessary.

In the present invention, the scene delimitation estimation technique is not limited to a certain technique. Although the scene delimitation is determined based on dissimilarity using the luminance signals and the chromaticity signal or the color temperature signal between adjacent frames in the above examples, the scene delimitation may be estimated based on dissimilarity acquired by comparing two frames at wider intervals. In this case, for example, the scene delimitation may be estimated by paying attention to a characteristic pattern of the luminance signal, etc., appearing between two frames.

The scene delimitation estimation technique is not limited to that utilizing video data, and the audio data accompanying the video data may also be used. For example, the switching of scene may be estimated from differences between left and right sounds at the time of stereophonic sound, or the switching of scene may be estimated from a change of audio frequency.

By implementing the form of transmitting scene delimiting position information added to the video data by a broadcast station, the scene delimiting position information can be utilized to control the illumination light for each scene. An embodiment of a view environment control system will hereinafter be described where the broad cast station (data transmission side) transmits the scene delimiting position information added to the video data, and on the reception side, the video/audio of the broadcast data are reproduced and the view environment lighting at that time is controlled.

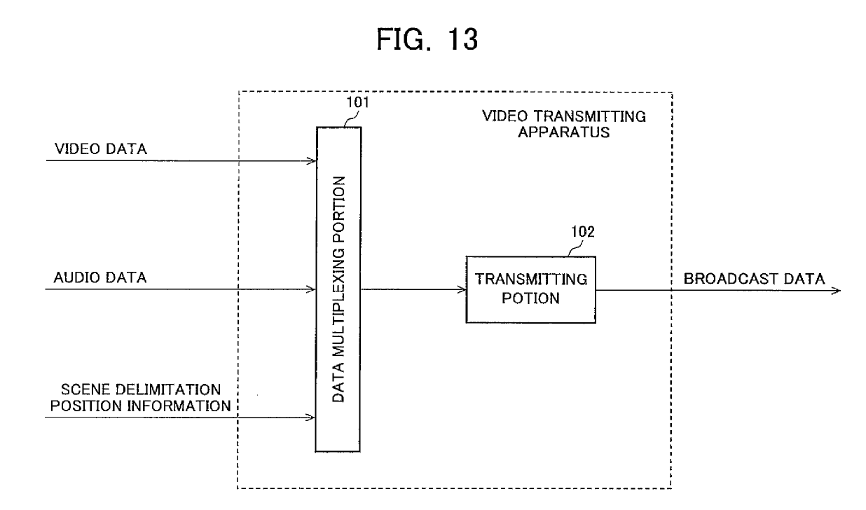

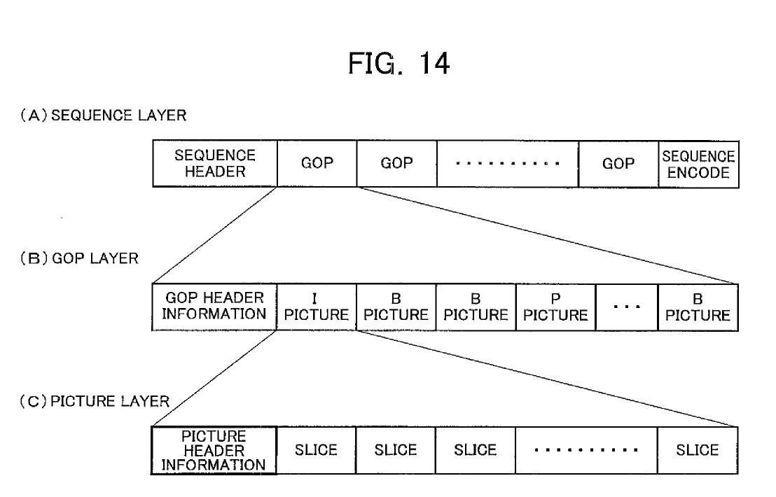

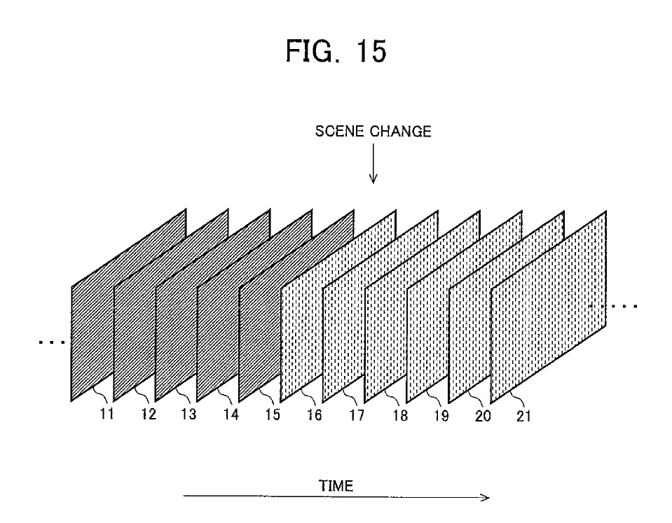

FIGS. 13 to 19 are views for explaining yet another embodiment of the present invention; FIG. 13 is a block diagram of a main outline configuration of a video transmitting apparatus in a view environment control system of this embodiment; FIG. 14 is a view for explaining a layer configuration of encoded data of a moving image encoded in MPEG; and FIG. 15 is a view for explaining a scene change.

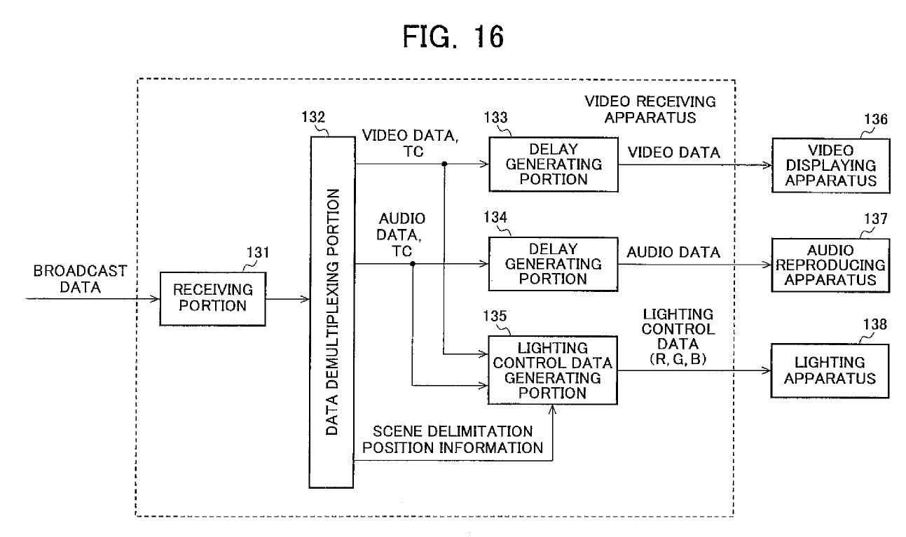

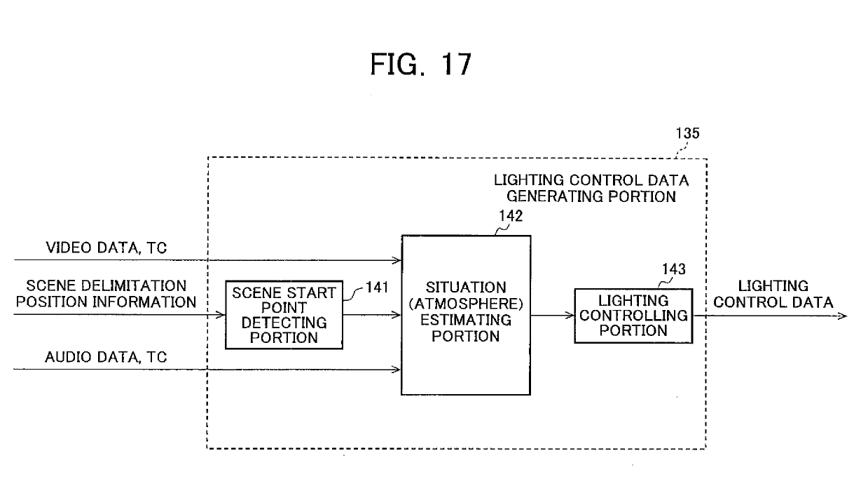

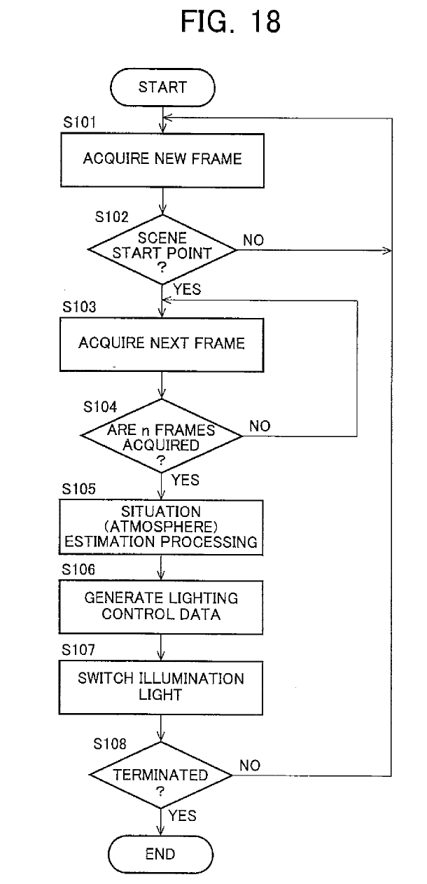

FIG. 16 is a block diagram of a main outline configuration of a video receiving apparatus in the view environment control system of this embodiment; FIG. 17 is a block diagram of a lighting control data generating portion of FIG. 16; and FIG. 18 is a flowchart of the operation of the lighting control data generating portion in the view environment control system of this embodiment.

As shown in FIG. 13, the video transmitting apparatus (data transmitting apparatus) of this embodiment includes a data multiplexing portion 101 that multiplexes video data, audio data, and scene delimitation position information supplied as additional data, and a transmitting portion 102 that modulates and sends out to a transmission channel the output data of the data multiplexing portion 101 after adding the error-correcting code. The scene delimitation position information is the information indicating the delimitation positions of scenes making up video data and indicates the start frames of video scenes in this case.

FIG. 14 is an explanatory view of a partial outline of a layered configuration of moving-image encoded data prescribed in the MPEG2 (Moving Picture Experts Group 2)-Systems. The encoded data consisting of a plurality of consecutive pictures have a layered configuration of six layers, which are a sequence layer, a GOP (Group Of Picture) layer, a picture layer, a slice layer, a macro block layer, and a block layer (not shown), and the data of the picture layer has picture header information at the forefront, followed by the data (slices) of a plurality of the slice layers.

The picture header information region is provided with a user data (extensions and user data) region capable of having arbitrary additional information written thereon as well as a picture header region (picture header) having written thereon various pieces of predetermined information such as a picture type and a scale of the entire frame, and the scene delimitation position information is written on this user data region in this embodiment. For example, in the case of a moving-image sequence shown in FIG. 15, eight-bit scene delimitation position information, which is “00000001” for a video-scene switching start frame 16 and “00000000” for other frames 11 to 15, 17 to 12 is added as user data of frame.

It is needless to say that the scene delimitation position information may be written on the user data region of the above described picture layer when the video data are encoded in a predetermined mode. In the present invention, any information enabling the identification of the frame serving as a scene changing point in the scenario (script) may be added to the video data or the audio data, and a data configuration in that case is not limited to that described above. For example, the information indicating the scene start frame may be transmitted by adding to an extension header of a transport stream packet (TSP) prescribed in the MPEG2-Systems.

The above scene delimitation position information can be generated based on the scenario (script) at the time of the video shooting and, in this case, as compared to the scene changing point determined based on the variation quantity of the video data, a scene changing point reflecting the intention of the video producers can be expressed, and the switching control of the view environment lighting described later can appropriately be performed.

By the way, as described above with reference to FIG. 2, video data making up a continuing moving-image sequence may be considered to have three-layered configuration. The first layer of video is a frame. The frame is a physical layer and indicates a single two-dimensional image. The frame is normally acquired at a rate of 30 frames per second. The second layer is a shot. The shot is a frame sequence shot by a single camera. The third layer is a scene. The scene is a shot sequence having a connection as a story between each shot.

In this case, as described above, the scene delimitation position information can be added on the basis of a frame of video data to indicate a frame corresponding to the timing when it is desirable to switch the view environment lighting (described later) in accordance with the intention of video producers (such as a scenario writer and a director).

A video receiving apparatus (data receiving apparatus) will then be described that receives the broadcast data sent out from the video transmitting apparatus, displays/reproduces video/sound and controls the view environment lighting at that time.

As shown in FIG. 16, the video receiving apparatus (data receiving apparatus) of this embodiment includes a receiving portion 131 that receives and demodulates the broadcast data input from the transmission channel and performs error correction; a data demultiplexing portion 132 that demultiplexes/extracts the video data and TC (time code) to be output to a video displaying apparatus 136, the audio data and TC (time code) to be output to a sound reproducing apparatus 137, and the scene delimitation position information as additional information, respectively from the output data of the receiving portion 131; a lighting control data generating portion 135 that generates the lighting control data (RGB data) adapted to the situation setting (atmosphere) of scenes based on the scene delimitation position information demultiplexed by the data demultiplexing portion 132 and the feature quantities of the video data and the audio data, and output the data to a lighting apparatus 138 for illuminating the view environment space; and delay generating portions 133, 134 that output the video data and the audio data with the delay of the processing time in the lighting control data generating portion 135.

The lighting apparatus 138 can be made up of LEDs that emit lights of three primary colors, for example, RGB having predetermined hues. However, the lighting apparatus 138 may have any configuration which can control the lighting color and brightness of the surrounding environment of the video displaying apparatus 136, is not limited to the combination of LEDs emitting predetermined colors as above, and may be made up of white LEDs and color filters, or a combination of white bulbs or fluorescent tubes and color filters, color lamps, etc., may also be applied. One or a plurality of the lighting apparatuses 138 may be disposed.

The time code is information added to indicate reproduction time information of each of the video data and the audio data and is made up of information indicating hours (h):minutes (m):seconds (s):frames (f) of the video data, for example.

As shown in FIG. 17, the lighting control data generating portion 135 of this embodiment includes a scene start point detecting portion 141 that detects the start frame of a scene section based on the scene delimitation position information; the situation (atmosphere) estimating portion 142 that extracts the video data and the audio data for a predetermined time from the start point TC of a scene section to estimate the lighting condition and the situation setting (atmosphere) of the shooting location based on these data; and a lighting controlling portion 143 that outputs the lighting control data for controlling the lighting apparatus 138 based on the estimation result of the situation (atmosphere) estimating portion 142.

Various technologies including known technologies can be used for the method of estimating the surrounding light state at the time of shooting by the situation (atmosphere) estimating portion 142. Although the feature quantity of the audio data is used along with the feature quantity of the video data to estimate the situation (atmosphere) of scenes here, this is for the purpose of improving the estimation accuracy of the situation (atmosphere) and the situation (atmosphere) may be estimated only from the feature quantity of the video data.

For the feature quantity of the video data, for example, the color signals and the luminance signals in a predetermined area of a screen can directly be used as in the case of the above conventional examples, or the color temperature of the surrounding light at the time of the video shooting may be obtained from these signals. The signals and the temperature can be switched and output as the feature quantity of the video data in some configurations. Sound volume, audio frequencies, etc., can be used for the feature quantity of the audio data.

The situation (atmosphere) estimating portion 142 estimates the color and brightness of the surrounding light at the time of the video shooting based on the feature quantities of the video data and the audio data, and in this case, for example, video data and audio data of a predetermined number of frames at the beginning part are accumulated for each of scenes to estimate the situation (atmosphere) of the scenes from the feature quantities of the accumulated video data and audio data. The situation (atmosphere) of the scene corresponds to the state of the illumination light when the video is shot, as described above.

The number n of the frames accumulated for estimating the situation (atmosphere) of the scene may preliminarily be defined by default (e.g., n=100 frames) or may arbitrarily and variably be set in accordance with user's operations. As above, the lighting control data can be generated for each video scene in accordance with the scene delimitation position information added to the broadcast data and substantially the same view environment illumination light can be retained in the same scene.

On the other hand, since the video data and the audio data output to the video displaying apparatus 136 and the sound reproducing apparatus 137 are delayed by the delay generating portions 133, 134 for a time required for the accumulation processing and the situation (atmosphere) estimation processing of the video data and the audio data described above, the lighting control data output from the video receiving apparatus to the lighting apparatus 138 are synchronized with the video data and the audio data output to the video displaying apparatus 136 and the sound reproducing apparatus 137, and the illumination light of the lighting apparatus 138 can be switched at the timing corresponding to the switching of the displayed video scenes.

A flow of the processing in the lighting control data generating portion 135 will then be described with reference to a flowchart of FIG. 18. First, a new frame is acquired from the input video data (step S101) and it is determined based on the scene delimitation position information whether the acquired frame is the scene start point (frame) (step S102). If the acquired frame is not the scene start point, the flow goes back to step S101 to further acquire a new frame and the scene start point detection processing is executed. If the acquired frame is the scene start point, the next frame is further acquired (step S103).

It is then determined whether the number of acquired frames from the scene start point reaches predetermined n frames by acquiring the next frame at step S103 (step S104). If the number of accumulated frames from the scene start point does not reach n frames, the flow goes back to step S103 to acquire the next frame. If the number of accumulated frames from the scene start point reaches n frames, the flow goes to the situation (atmosphere) estimation processing. The video data of the acquired n frames are accumulated in a video data accumulating portion (not shown).

The video/audio feature quantities are then detected with the use of the video data/audio data of the n frames accumulated in the video data accumulating portion to execute the estimation processing of the situation (atmosphere) of the scene (step S105), and the lighting control data for controlling the lighting apparatus 5 are generated based on the estimation processing result (step S106). The switching control of the illumination light is performed by the lighting apparatus 138 based on the lighting control data (step S107), and it is then determined whether the processing is terminated (step S108). For examples if the video data are terminated, the scene section detection processing and the situation (atmosphere) estimation processing are also terminated, and if the video data further continue, the flow goes back to step S101 to acquired a new frame.

Since the view environment lighting is configured to be controlled with the use of the scene delimitation position information and the video data and/or the audio data as above in this embodiment, the switching control of the view environment lighting can be performed on the basis of a scene corresponding to the intention of video producers. That is, since the brightness and color of the view environment illumination light can be retained substantially constant in the same scene, the sense of reality and the atmosphere can be prevented from being deteriorated due to sharp fluctuations of the view environment lighting in the same scene and the appropriate view environment can always he implemented.

Since the scene delimitation position information is transmitted and received to indicate the delimitation positions of the set situations in the story of scenes in this environment, various functions other than the control of the view environment lighting can be implemented such as searching and editing desired scenes with the use of the scene delimitation position information.

Although the information indicating only the start frames of the video scenes is transmitted and received as the scene delimitation position information in the above embodiment, the information indicating the end frames of the video scenes may additionally be transmitted and received. If the information indicating the end frames of the video scenes is also transferred and received as above, the situation (atmosphere) estimation processing and the view environment illumination light switching control can appropriately be executed even for a very short video scene. If a short shot (such as a telop) not belonging to any scene is inserted between scenes, the lighting control can be performed not to switch the view environment lighting or to emit, for example, white light with predetermined brightness for this shot.

Although the information is written at the least significant bit of eight bits prescribed as user data to indicate whether the frame is the scene switching start frame in the above embodiment, other pieces of information may be written at seven higher-order bits and, for example, information may be written that is related to the view environment lighting control when displaying a scene started from the frame. In this case, the view environment lighting control information may be added as the user data of frames along with the scene delimitation position information to indicate (1) whether the switching control of the illumination light is performed in accordance with the video/audio feature quantities of the scene started from the frame, (2) whether the illumination light corresponding to the video/audio feature quantities of the last scene is maintained regardless of the video/audio feature quantities of the scene started from the frame, or (3) whether the switching control to the illumination light (such as white illumination light) set by default is performed. This enables the appropriate view environment lighting control corresponding to the characteristics of the scenes.

Although the case of transmitting the scene delimitation position information added to the broadcast data has been described in the above embodiment, if the scene delimitation position information is not added to the broadcast data, the appropriate view environment can be realized on the bases of video scenes by transmitting and receiving the scene delimitation position information corresponding to the video data to be displayed with an external server apparatus, etc. This will hereinafter be described as yet another embodiment of the present invention.

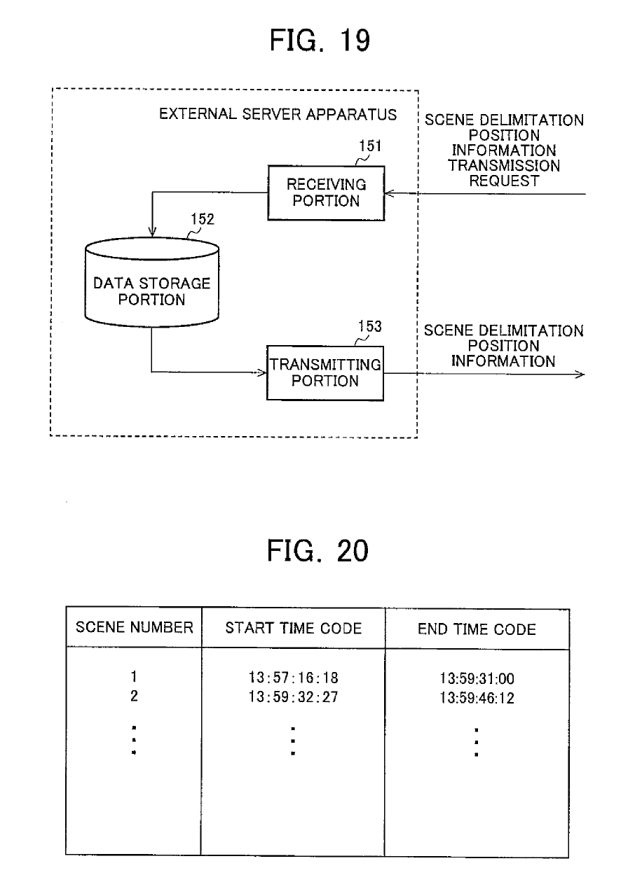

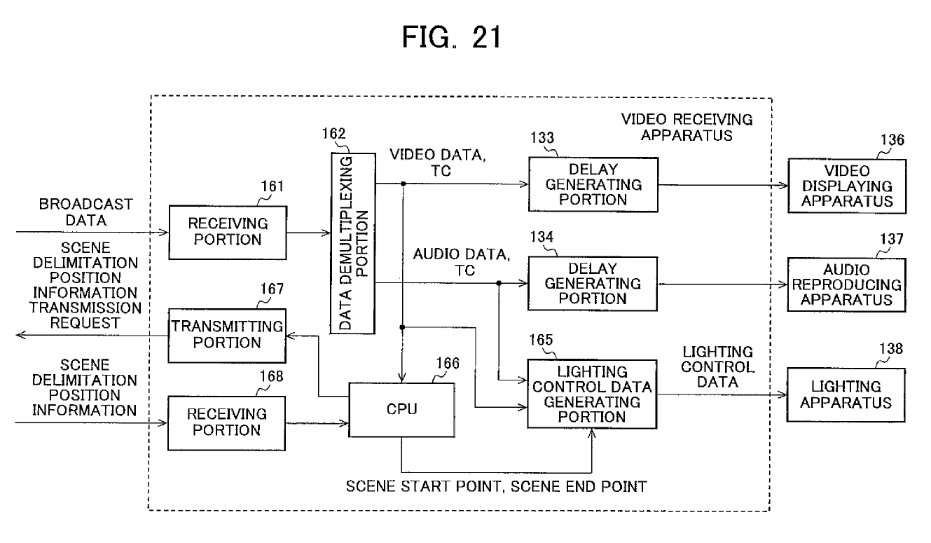

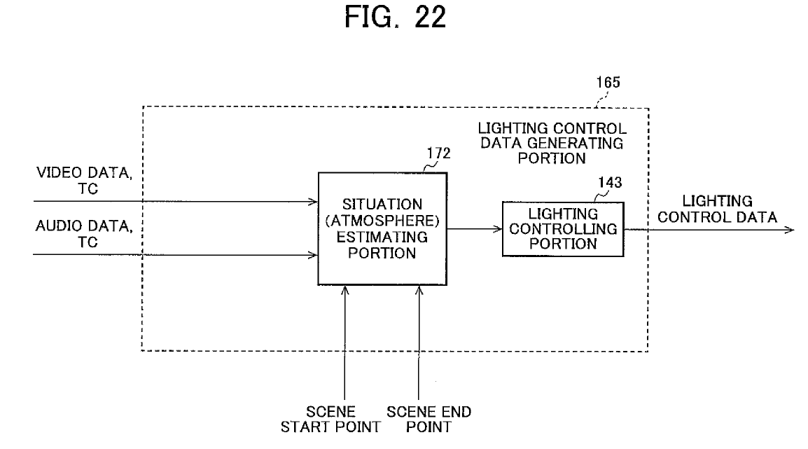

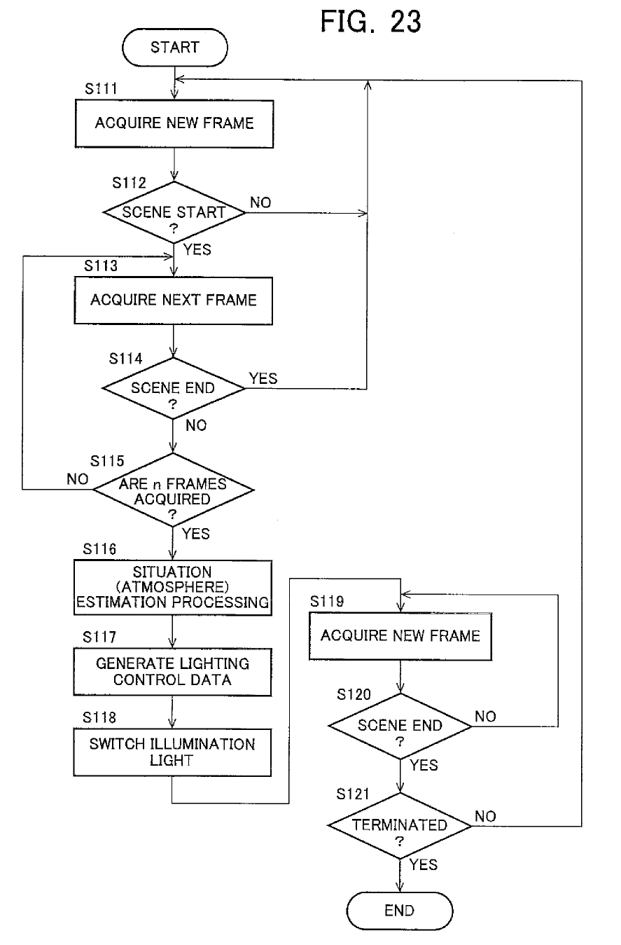

FIG. 19 is a block diagram of a main outline configuration of an external server apparatus in the view environment control system of this embodiment; FIG. 20 is an explanatory view of an example of a scene delimitation position information storage table in the view environment control system of this embodiment; FIG. 21 is a block diagram of a main outline configuration of a video receiving apparatus in the view environment control system of this embodiment; FIG. 22 is a block diagram of a lighting control data generating portion of FIG. 21; and FIG. 23 is a flowchart of the operation of the lighting control data generating portion in the view environment control system of this embodiment. In the figures, the same portions as those in the above embodiments have the same reference numerals and will not be described.

As shown in FIG. 19, the external server apparatus (data transmitting apparatus) of this embodiment includes a receiving portion 151 that receives a transmission request for the scene delimitation position information related to certain video data (contents) from the video receiving apparatus (data receiving apparatus), a data storage portion 152 that has stored thereon the scene delimitation position information for each piece of video data (contents), and a transmitting portion 153 that transmits the scene delimitation position information requested for transmission to the requesting video receiving apparatus (data receiving apparatus).

As shown in FIG. 20, the scene delimitation position information stored in the data storage portion 152 of the embodiment is described in a table format which corresponded the scene start time code and the scene end time code with the scene numbers of video scenes, and the scene delimitation position information of video data (program contents) requested for transmission is transmitted by the transmitting portion 153 to the requesting video receiving apparatus along with the scene numbers of the scenes making up the video data, the scene start TC (time code), and the scene end TC (time code).

The video receiving apparatus (data receiving apparatus) will then be described that receives the scene delimitation position information sent out from the external server apparatus to control the view environment lighting. As shown in FIG. 21, the video receiving apparatus of this embodiment includes a receiving portion 161 that receives and demodulates the broadcast data input from the transmission channel and performs error correction; a data demultiplexing portion 162 that demultiplexes/extracts the video data to be output to the video displaying apparatus 136 and the audio data to be output to the sound reproducing apparatus 137 from the output data of the receiving portion 161; a transmission portion 167 that sends out the transmission request for the scene delimitation position information corresponding to the video data (contents) to be displayed to the external server apparatus (data transmitting apparatus) through a communication network; and a receiving portion 168 that receives the scene delimitation position information requested for transmission from the external server apparatus through the communication network.

The video receiving apparatus also includes a CPU that temporarily stores the scene delimitation position information received by the receiving portion 168 to compare the scene start TC (time code) and the scene end TC (time code) included in the scene delimitation position information with the TC (time code) of the video data extracted by the data demultiplexing portion 162 and that outputs information indicating whether or not a frame of the video data extracted by the data demultiplexing portion 162 are the scene start point (frame) or the scene end point (frame), and a lighting control data generating portion 165 that estimates the situation (atmosphere) of scene sections with the use of the information indicating the scene start point (frame) and the scene endpoint (frame) from the CPU 166 to output the lighting control data (RGB data) corresponding to the estimation result to the lighting apparatus 138 illuminating the view environment space.

That is, the CPU 166 compares the internally stored the start time code and end time code of each scene of the scene delimitation position information storage table that is received from the external server apparatus with the time code of the video data input to the lighting control data generating portion 165, and when these time codes are identical, the CPU 166 outputs the scene stat point information and the scene end point information to the lighting control data generating portion 165.

As described in FIG. 22, the lighting control data generating portion 165 of the embodiment includes a situation (atmosphere) estimating portion 172 that extracts the video data and the audio data for a predetermined time from the start point TC of a scene section to estimate the lighting condition and the situation setting (atmosphere) of the shooting location based on these data, and a lighting controlling portion 143 that outputs the lighting control data for controlling the lighting apparatus 138 based on the estimation result of the situation (atmosphere) estimating portion 172.

Various technologies including known technologies can be used for the method of estimating the surrounding light state at the time of shooting by the situation (atmosphere) estimating portion 172. Although the feature quantity of the audio data is used along with the feature quantity of the video data to estimate the situation (atmosphere) of scenes here, this is for the purpose of improving the estimation accuracy of the situation (atmosphere) and the situation (atmosphere) may be estimated only from the feature quantity of the video data.

For the feature quantity of the video data, for example, the color signals and the luminance signals in a predetermined area of a screen can directly be used as in the case of the above conventional examples, or the color temperature of the surrounding light at the time of the video shooting may be obtained from these signals. The signals and the temperature can be switched and output as the feature quantity of the video data in some configurations. Sound volume, audio frequencies, etc., can be used for the feature quantity of the audio data.

The situation (atmosphere) estimating portion 172 estimates the color and brightness of the surrounding light at the time of the video shooting based on the feature quantities of the video data and the audio data, and in this case, for example, video data and audio data of a predetermined number of frames at the beginning part are accumulated for each of scenes to estimate the situation (atmosphere) of the scenes from the feature quantities of the accumulated video data and audio data. The situation (atmosphere) of the scene corresponds to the state of the illumination light when the video is shot, as described above.

The number n of the frames accumulated for estimating the situation (atmosphere) of the scene may preliminarily be defined by default (e.g., n=100 frames) or may arbitrarily and variably be set by user's operations. As above, the lighting control data can be generated for each video scene in accordance with the scene delimitation position information added to the broadcast data and substantially the same viewing-environment illumination light can be retained in the same scene.

On the other hand, since the video data and the audio data output to the video displaying apparatus 136 and the sound reproducing apparatus 137 are delayed by the delay generating portions 133, 134 for a time required for the accumulation processing and the situation (atmosphere) estimation processing of the video data and the audio data described above, the lighting control data output from the video receiving apparatus to the lighting apparatus 138 are synchronized with the video data and the audio data output to the video displaying apparatus 136 and the sound reproducing apparatus 137, and the illumination light of the lighting apparatus 138 can be switched at the timing corresponding to the switching of the displayed video scenes.

A flow of the processing in the lighting control data generating portion 165 will then be described with reference to a flowchart of FIG. 23. First, a new frame is acquired from the input video data (step S111) and it is determined based on the scene start point information whether the acquired frame is the scene start point (frame) (step S112). If the acquired frame is not the scene start point, the flow goes back to step S111 to further acquire a new frame and the scene start point detection processing is executed.

If the acquired frame is the scene start point, the next frame is further acquired (step S113) and it is determined based on the scene end point information whether the acquired frame is the scene end point (frame) (step S114). If the acquired frame is the scene end point, the flow goes back to step S111 to acquire a new frame.

If the acquired frame is not the scene end point at step S114, it is determined whether the number of acquired frames reaches predetermined n frames from the scene start point (step S115). If the number of accumulated frames from the scene start point does not reach n frames, the flow goes back to step S113 to acquire the next frame. If the number of accumulated frames from the scene start point reaches n frames, the flow goes to the situation (atmosphere) estimation processing. The video data of the acquired n frames are accumulated in a video data accumulating portion (not shown).

The video/audio feature quantity are then detected with the use of the video data/audio data of the n frames accumulated in the video data accumulating portion to execute the estimation processing of the situation (atmosphere) of the scene (step S116), and the lighting control data for controlling the lighting apparatus 138 are generated based on the estimation processing result (step S117). The switching control of the illumination light is performed by the lighting apparatus 138 based on the lighting control data (step S118). The next frame is subsequently acquired (step S119) and it is determined whether the acquired frame is the scene end point (frame) (step S120). If the scene does not end here, the flow goes back to step S119 to acquire the next frame. If the scene ends, it is further determined whether the processing is terminated (step S121). For example, if the video data are terminated, the scene section detection processing and the situation (atmosphere) estimation processing are also terminated, and if the video data further continue, the flow goes back to step S111 to acquired a new frame.

Since the scene delimitation position information corresponding to the display video data (program contents) can be obtained from the external server apparatus even when the scene delimitation position information is not added to the broadcast data and the view environment lighting is controlled with the use of this scene delimitation position information and the video data and/or audio data in this configuration, the switching control of the view environment lighting can be performed on the basis of a scene corresponding to the intention of video producers. That is, since the brightness and color of the view environment illumination light can be retained substantially constant in the same scene, the sense of reality and the atmosphere can be prevented from being deteriorated due to sharp fluctuations of the view environment lighting in the same scene and the appropriate view environment can always be implemented.

Since the scene delimitation position information indicating the delimitation positions of the set situations in the story of scenes is acquired from the external server apparatus in this environment, various functions other than the control of the view environment lighting can be implemented such as searching and editing desired scenes with the use of the scene delimitation position information.

Since the information indicating the end frames of the video scenes is transmitted and received as the scene delimitation position information in addition to the information indicating the start frames of the video scenes in the above embodiment, the situation (atmosphere) estimation processing and the view environment illumination light switching control can appropriately be executed even for a very short video scene. If a short shot (such as a telop) not belonging to any scene is inserted between scenes, the lighting control can be performed not to switch the view environment lighting or to emit, for example, white light with predetermined brightness for this shot.

Although information representing the start frames and the end frames of scenes is written as the scene delimitation position information on the scene delimitation position information storage table in the above embodiment, other pieces of information may additionally be written and, for example, the information related to the view environment lighting control at the time of displaying scenes may be written on the scene delimitation position information storage table. In this case, the view environment lighting control information may be written on the scene delimitation position information storage table along with the information representing the start frames and the end frames of scenes to indicate (1) whether the switching control of the illumination light is performed in accordance with the video/audio feature quantities of the scene, (2) whether the illumination light corresponding to the video/audio feature quantities of the last scene is maintained regardless of the video/audio feature quantities of the scenes or (3) whether the switching control to the illumination light (such as white illumination light) set by default is performed. This enables the appropriate view environment lighting control corresponding to the characteristics of the scenes.

The view environment controlling apparatus, the method, and the view environment controlling system can be implemented in various embodiments without departing from the gist of the present invention. For example, the view environment controlling apparatus may be disposed within the video displaying apparatus and may obviously be configured such that the external lighting devices can be controlled based on various pieces of information included in the input video data.

The above scene delimitation position information is not limited to be demultiplexed/acquired from the broadcast data or acquired from the external server apparatus and, if the video information reproduced by external apparatuses (such as DVD players and Blu-ray disc players) is displayed, the scene delimitation position information added to a medium may be read and used.

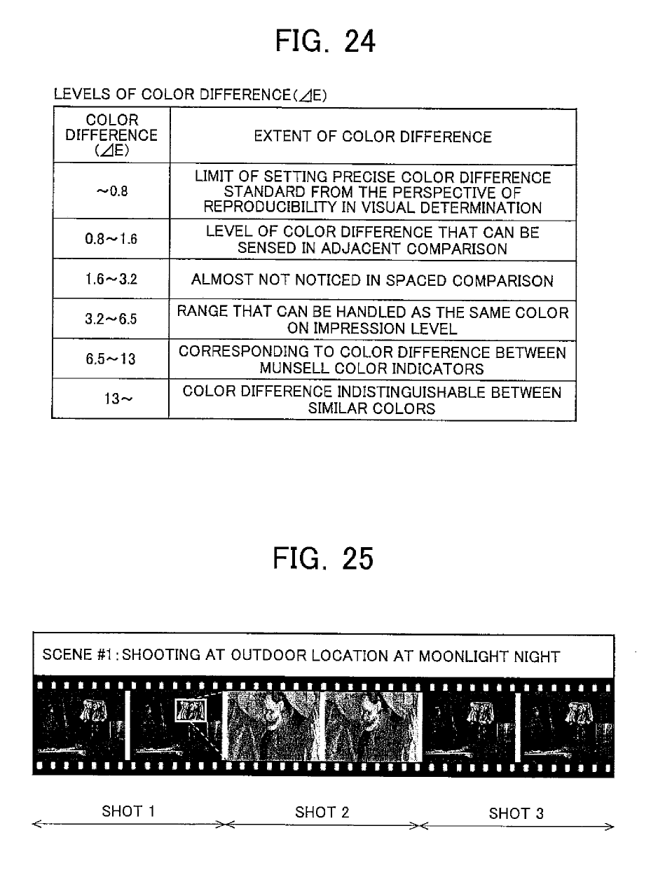

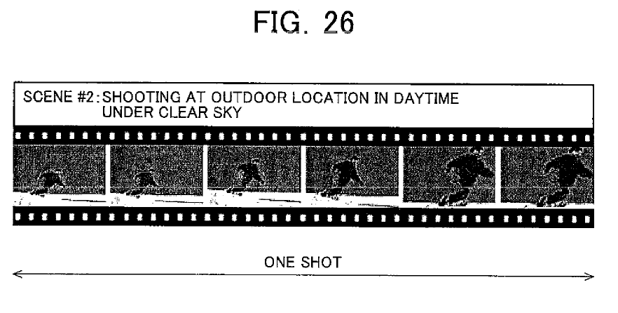

As elaborated above, the present invention is characterized in that the brightness and color of the illumination light of the lighting apparatus disposed around the displaying apparatus are retained substantially constant, and the term “substantially constant” as used herein indicates the extent and range of fluctuations of the illumination light not impairing the sense of reality for viewers. It is well known at the time of filing of this application that the allowable color difference exists in the human visual sense and, for example, FIG. 24 depicts levels of the color difference ΔE and general degrees of visual sense. Although it is preferable that the substantially constant range in the present invention is a range that can be handled as the same color on the impression level in FIG. 24, i.e., a level range equal to or less than a color difference ΔE=6.5, the difference may be within a range that can be handled as a color difference indistinguishable between similar colors, i.e., a level range less than a color difference ΔE=13.

Even when the illumination color is controlled to be faded immediately after the start of a scene or immediately before the end of a scene, it is apparent that keeping the brightness and color of the illumination light substantially constant during that period falls within the technical range of the present invention.

1. A view environment controlling apparatus controlling illumination light of a lighting device in accordance with a feature quantity of video data to be displayed, wherein
the illumination light of the lighting device is retained substantially constant in the same scene of the video data.

2. The view environment controlling apparatus as defined in claim 1, comprising:
a scene section detecting means that detects a section of a scene making up the video data;
a video feature quantity detecting means that detects a video feature quantity of each scene detected by the scene section detecting means; and
a lighting switch controlling means that switches and controls the illumination light of the lighting device for each scene based on the detection result of the video feature quantity detecting means.

3. The view environment controlling apparatus as defined in claim 2, comprising:
a scene lighting data storage means that stores the detection result detected by the video feature quantity detecting means for each scene and time codes of scene start point and scene end point of each scene detected by the scene section detecting means as scene lighting data; and
a video data storage means that stores the video data along with time code,
wherein the lighting switch controlling means switches and controls the illumination light of the lighting device for each scene based on the scene lighting data read from the scene lighting data storage means and the time codes read from the video data storage means.

4. The view environment controlling apparatus as defined in claim 2, comprising
a video data accumulating means that accumulates video data of a predetermined number of frames after the scene start point of each scene detected by the scene section detecting means,
wherein the video feature quantity detecting means uses the video data accumulated on the video data accumulating means to detect a video feature quantity of a scene started from the scene start point.

5. The view environment controlling apparatus as defined in claim 4, comprising
a video data delaying means that outputs the video data to be displayed with a delay of a predetermined time.

6. A view environment control system comprising the view environment controlling apparatus as defined in any one of claims 1 to 5 and a lighting device having view environment illumination light controlled by the view environment controlling apparatus.

7. A view environment controlling method of controlling illumination light of a lighting device in accordance with a feature quantity of video data to be displayed,
wherein the illumination light of the lighting device is retained substantially constant in the same scene of the video data.

8. The view environment controlling method as defined in claim 7, comprising:
a scene section detecting step of detecting a section of a scene making up the video data;
a video feature quantity detecting step of detecting a video feature quantity of each scene detected at the scene section detecting step; and
a lighting switch determining step of switching and controlling the illumination light of the lighting device for each scene based on the detection result of the video feature quantity detecting step.

9. The view environment controlling method as defined in claim 8,
wherein the scene section detecting step includes the steps of:
detecting a scene start point for every frame of video data;
recording the time code of the scene start point when the scene start point is detected;
detecting a scene end point for every frame subsequent to the scene start point after the scene start point is detected; and
recording the time code of the scene end point when the scene detection point is detected, and
wherein the video feature quantity detecting step includes the steps of:
reproducing video data of a scene section corresponding to the time codes of the recorded scene start point and scene end point; and
detecting the video feature quantity of the scene with the use of the reproduced video data.

10. The view environment controlling method as defined in claim 8, wherein the scene section detecting step includes the step of detecting a scene start point from video data,
wherein the method further comprises the step of acquiring video data of a predetermined number of frames subsequent to the scene start point when the scene start point is detected, and
wherein at the video feature quantity detecting step, the acquired video data of the predetermined number of frames are used to detect the video feature quantity of the scene started from the scene start point.

11. The view environment controlling method as defined in claim 8, wherein the scene section detecting step includes the step of detecting a scene start point from video data, and
the step of detecting a scene end point from the video data,
wherein the method further comprises the step of acquiring video data of a predetermined number of frames subsequent to the scene start point when the scene start point is detected, and
the step of detecting a scene start point form the video data again if the scene end point is detected before acquiring the video data of a predetermined number of frames subsequent to the scene start point, and
wherein at the video feature quantity detecting step, the video feature quantity of the scene started from the scene start point is detected using the acquired video data of the predetermined number of frames.

12. The view environment controlling method as defined in claim 10 or 11, wherein the video data to be displayed are output with a delay of a predetermined time.

13. A data transmitting apparatus transmitting video data made up of one or more scenes, wherein
scene delimitation position information indicating delimitation position of each scene of the video data is transmitted in addition to the video data.

14. The data transmitting apparatus as defined in claim 13, wherein the scene delimitation position information is added per frame of the video data.

15. A data transmitting apparatus transmitting scene delimitation position information indicating delimitation position of each scene making up video data in response to a request from the outside, wherein
the scene delimitation position information represents start frame of each scene making up the video data.

16. The data transmitting apparatus as defined in claim 15, wherein the scene delimitation position information represents start frame of each scene making up the video data and end frames of the scenes.

17. A view environment controlling apparatus comprising:
a receiving means that receives video data to be displayed on a displaying device and scene delimitation position information indicating delimitation position of each scene making up the video data, and
a controlling means that uses a feature quantity of the video data and the scene delimitation position information to control illumination light of a lighting device disposed around the displaying device.

18. The view environment controlling apparatus as defined in claim 17, wherein the controlling means retains the illumination light of the lighting device substantially constant in the same scene of the video data.

19. A view environment control system comprising the view environment controlling apparatus as defined in claim 17 or 18 and a lighting device having view environment illumination light controlled by the view environment controlling apparatus.

20. A data transmitting method of transmitting video data made up of one or more scenes,
wherein scene delimitation position information indicating delimitation position of each scene of the video data is transmitted in addition to the video data.

21. A data transmitting method of transmitting scene delimitation position information indicating delimitation position of each scene making up video data in response to a request from the outside,
wherein the scene delimitation position information represents start frame of each scene making up the video data.

22. A view environment controlling method comprising the steps of:
receiving video data to be displayed on a displaying device and scene delimitation position information indicating delimitation position of each scene making up the video data, and
controlling illumination light of a lighting device disposed around the displaying device using a feature quantity of the video data and the scene delimitation position information.

23. The view environment controlling method as defined in claim 22, wherein the illumination light of the lighting device is retained substantially constant in the same scene of the video data.
